(19) United States
(12) Patent Application Publication
(10) Pub. No.: US 2024/0348371 A1
(43) Pub. Date: Oct. 17, 2024

(54) RECOVERING PROCEDURE FOR INTER USER EQUIPMENT COORDINATION MESSAGE REQUEST AND RESPONSE FAILURE

(71) Applicant: QUALCOMM Incorporated, San Diego, CA (US)

(72) Inventors: Hui GUO, Beijing (CN); Tien Viet NGUYEN, Bridgewater, NJ (US); Sourjya DUTTA, San Diego, CA (US); Shijun WU, San Diego, CA (US); Gabi SARKIS, San Diego, CA (US); Kapil GULATI, Belle Mead, NJ (US)

(21) Appl. No.: 18/292,682

(22) PCT Filed: Sep. 28, 2021
(86) PCT No.: PCT/CN2021/121389

§ 371 Date: Jan. 26, 2024

(51) Int. Cl. H04L 1/16; H04W 72/02; H04W 92/18

(52) U.S. Cl. CPC H04L 1/16; H04W 72/02; H04W 92/18

(57) ABSTRACT

Various aspects of the present disclosure generally relate to wireless communication. In some aspects, a user equipment (UE) may transmit, via sidelink communication, an inter-UE coordination request message requesting coordination information associated with selecting a first resource for transmitting data. The UE may transmit, based at least in part on receiving a negative acknowledgement associated with the inter-UE coordination request message or based at least in part on not receiving feedback associated with the inter-UE coordination request message within a time period, the data via a second resource that is selected based at least in part on sensing information obtained by the UE. Numerous other aspects are described.

### FIELD OF THE DISCLOSURE

Aspects of the present disclosure generally relate to wireless communication and to techniques and apparatuses for a recovering procedure for inter user equipment (inter-UE) coordination message request and response failure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, via sidelink communication, an inter-UE coordination request requesting coordination information associated with selecting a first resource for transmitting data. The method may include transmitting, based at least in part on receiving a negative acknowledgement associated with the inter-UE coordination request or based at least in part on not receiving feedback associated with the inter-UE coordination request within a time period, the data via a second resource that is selected based at least in part on sensing information obtained by the UE.

Some aspects described herein relate to a method of wireless communication performed by a UE. The method may include transmitting, via sidelink communication, an inter-UE coordination request requesting coordination information associated with selecting a first resource for transmitting data. The method may include receiving inter-UE coordination request feedback indicating a positive acknowledgement associated with the inter-UE coordination request. The method may include retransmitting the inter-UE coordination request via a second resource based at least in part on not receiving an inter-UE coordination message including the coordination information within a time period.

Some aspects described herein relate to a method of wireless communication performed by a UE. The method may include receiving, via sidelink communication, an inter-UE coordination request requesting coordination information associated with selecting a first resource for transmitting data. The method may include transmitting an inter-UE coordination message including the coordination information associated with selecting the first resource. The method may include retransmitting the inter-UE coordination message based at least in part on receiving inter-UE coordination message feedback indicating a negative acknowledgement associated with the inter-UE coordination message or based at least in part on not receiving the inter-UE coordination message feedback within a time period.

Some aspects described herein relate to a method of wireless communication performed by a UE. The method may include transmitting, via sidelink communication, an inter-UE coordination request requesting coordination information associated with selecting a first resource for transmitting data. The method may include receiving an inter-UE coordination message indicating the first resource. The method may include retransmitting the inter-UE coordination request based at least in part on determining that the first resource is unavailable for transmitting the data.

Some aspects described herein relate to a UE for wireless communication. The UE may include a memory and one or more processors coupled to the memory. The one or more processors may be configured to transmit, via sidelink communication, an inter-UE coordination request requesting coordination information associated with selecting a first resource for transmitting data. The one or more processors may be configured to transmit, based at least in part on receiving a negative acknowledgement associated with the inter-UE coordination request or based at least in part on not receiving feedback associated with the inter-UE coordination request within a time period, the data via a second resource that is selected based at least in part on sensing information obtained by the UE.

Some aspects described herein relate to a UE for wireless communication. The UE may include a memory and one or more processors coupled to the memory. The one or more processors may be configured to transmit, via sidelink communication, an inter-UE coordination request requesting coordination information associated with selecting a first resource for transmitting data. The one or more processors may be configured to receive inter-UE coordination request feedback indicating a positive acknowledgement associated with the inter-UE coordination request. The one or more processors may be configured to retransmit the inter-UE coordination request via a second resource based at least in part on not receiving an inter-UE coordination message including the coordination information within a time period.

Some aspects described herein relate to a UE for wireless communication. The UE may include a memory and one or more processors coupled to the memory. The one or more processors may be configured to receive, via sidelink communication, an inter-UE coordination request requesting coordination information associated with selecting a first resource for transmitting data. The one or more processors may be configured to transmit an inter-UE coordination message including the coordination information associated with selecting the first resource. The one or more processors may be configured to retransmit the inter-UE coordination message based at least in part on receiving inter-UE coordination message feedback indicating a negative acknowledgement associated with the inter-UE coordination message or based at least in part on not receiving the inter-UE coordination message feedback within a time period.

Some aspects described herein relate to a UE for wireless communication. The UE may include a memory and one or more processors coupled to the memory. The one or more processors may be configured to transmit, via sidelink communication, an inter-UE coordination request requesting coordination information associated with selecting a first resource for transmitting data. The one or more processors may be configured to receive an inter-UE coordination message indicating the first resource. The one or more processors may be configured to retransmit the inter-UE coordination request based at least in part on determining that the first resource is unavailable for transmitting the data.

Some aspects described herein relate to a non-transitory computer-readable medium that stores a set of instructions for wireless communication by a UE. The set of instructions, when executed by one or more processors of the UE, may cause the UE to transmit, via sidelink communication, an inter-UE coordination request requesting coordination information associated with selecting a first resource for transmitting data. The set of instructions, when executed by one or more processors of the UE, may cause the UE to transmit, based at least in part on receiving a negative acknowledgement associated with the inter-UE coordination request or based at least in part on not receiving feedback associated with the inter-UE coordination request within a time period, the data via a second resource that is selected based at least in part on sensing information obtained by the UE.

Some aspects described herein relate to a non-transitory computer-readable medium that stores a set of instructions for wireless communication by a UE. The set of instructions, when executed by one or more processors of the UE, may cause the UE to transmit, via sidelink communication, an inter-UE coordination request requesting coordination information associated with selecting a first resource for transmitting data. The set of instructions, when executed by one or more processors of the UE, may cause the UE to receive inter-UE coordination request feedback indicating a positive acknowledgement associated with the inter-UE coordination request. The set of instructions, when executed by one or more processors of the UE, may cause the UE to retransmit the inter-UE coordination request via a second resource based at least in part on not receiving an inter-UE coordination message including the coordination information within a time period.

Some aspects described herein relate to a non-transitory computer-readable medium that stores a set of instructions for wireless communication by a UE. The set of instructions, when executed by one or more processors of the UE, may cause the UE to receive, via sidelink communication, an inter-UE coordination request requesting coordination information associated with selecting a first resource for transmitting data. The set of instructions, when executed by one or more processors of the UE, may cause the UE to transmit an inter-UE coordination message including the coordination information associated with selecting the first resource. The set of instructions, when executed by one or more processors of the UE, may cause the UE to retransmit the inter-UE coordination message based at least in part on receiving inter-UE coordination message feedback indicating a negative acknowledgement associated with the inter-UE coordination message or based at least in part on not receiving the inter-UE coordination message feedback within a time period.

Some aspects described herein relate to a non-transitory computer-readable medium that stores a set of instructions for wireless communication by a UE. The set of instructions, when executed by one or more processors of the UE, may cause the UE to transmit, via sidelink communication, an inter-UE coordination request requesting coordination information associated with selecting a first resource for transmitting data. The set of instructions, when executed by one or more processors of the UE, may cause the UE to receive an inter-UE coordination message indicating the first resource. The set of instructions, when executed by one or more processors of the UE, may cause the UE to retransmit the inter-UE coordination request based at least in part on determining that the first resource is unavailable for transmitting the data.

Some aspects described herein relate to an apparatus for wireless communication. The apparatus may include means for transmitting, via sidelink communication, an inter-UE coordination request requesting coordination information associated with selecting a first resource for transmitting data. The apparatus may include means for transmitting, based at least in part on receiving a negative acknowledgement associated with the inter-UE coordination request or based at least in part on not receiving feedback associated with the inter-UE coordination request within a time period, the data via a second resource that is selected based at least in part on sensing information obtained by the UE.

Some aspects described herein relate to an apparatus for wireless communication. The apparatus may include means for transmitting, via sidelink communication, an inter-UE coordination request requesting coordination information associated with selecting a first resource for transmitting data. The apparatus may include means for receiving inter-UE coordination request feedback indicating a positive acknowledgement associated with the inter-UE coordination request. The apparatus may include means for retransmitting the inter-UE coordination request via a second resource based at least in part on not receiving an inter-UE coordination message including the coordination information within a time period.

Some aspects described herein relate to an apparatus for wireless communication. The apparatus may include means for receiving, via sidelink communication, an inter-UE coordination request requesting coordination information associated with selecting a first resource for transmitting data. The apparatus may include means for transmitting an inter-UE coordination message including the coordination information associated with selecting the first resource. The apparatus may include means for retransmitting the inter-UE coordination message based at least in part on receiving inter-UE coordination message feedback indicating a negative acknowledgement associated with the inter-UE coordination message or based at least in part on not receiving the inter-UE coordination message feedback within a time period.

Some aspects described herein relate to an apparatus for wireless communication. The apparatus may include means for transmitting, via sidelink communication, an inter-UE coordination request requesting coordination information associated with selecting a first resource for transmitting data. The apparatus may include means for receiving an inter-UE coordination message indicating the first resource. The apparatus may include means for retransmitting the inter-UE coordination request based at least in part on determining that the first resource is unavailable for transmitting the data.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communication, in accordance with the present disclosure.

FIG. 4 is a diagram illustrating an example of selecting sidelink resources, in accordance with the present disclosure.

FIGS. 5-8 are diagrams illustrating examples associated with a recovering procedure for inter-UE coordination message request and response failure, in accordance with the present disclosure.

FIGS. 9-12 are diagrams illustrating example processes associated with a recovering procedure for inter-UE coordination message request and response failure, in accordance with the present disclosure.

FIGS. 13-16 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

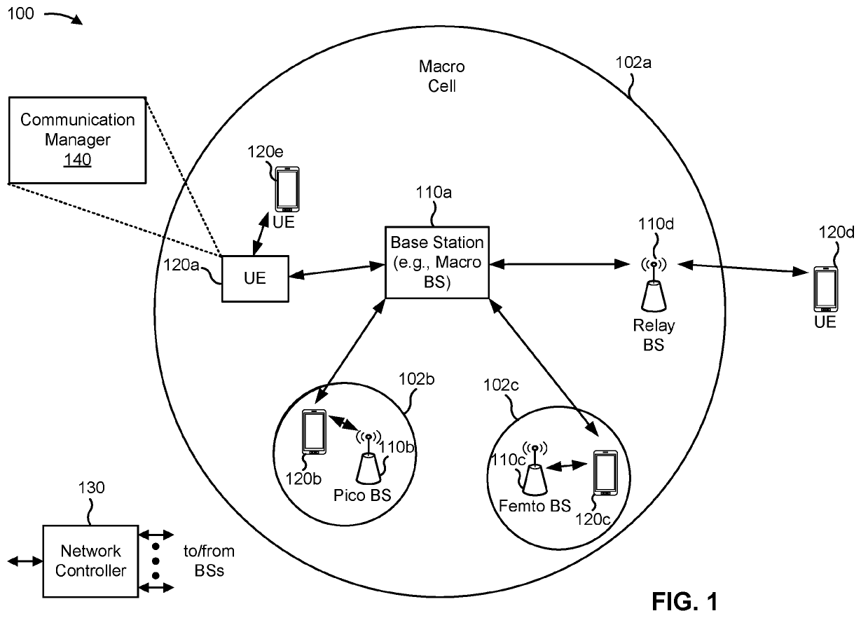

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may perform one or more operations associated with inter-UE coordination message request and response failure. Additionally, or alternatively, the communication manager 140 may perform one or more other operations described herein.

As indicated above, FIG. 1 is provided as an example. Other examples may differ from what is described with regard to FIG. 1.

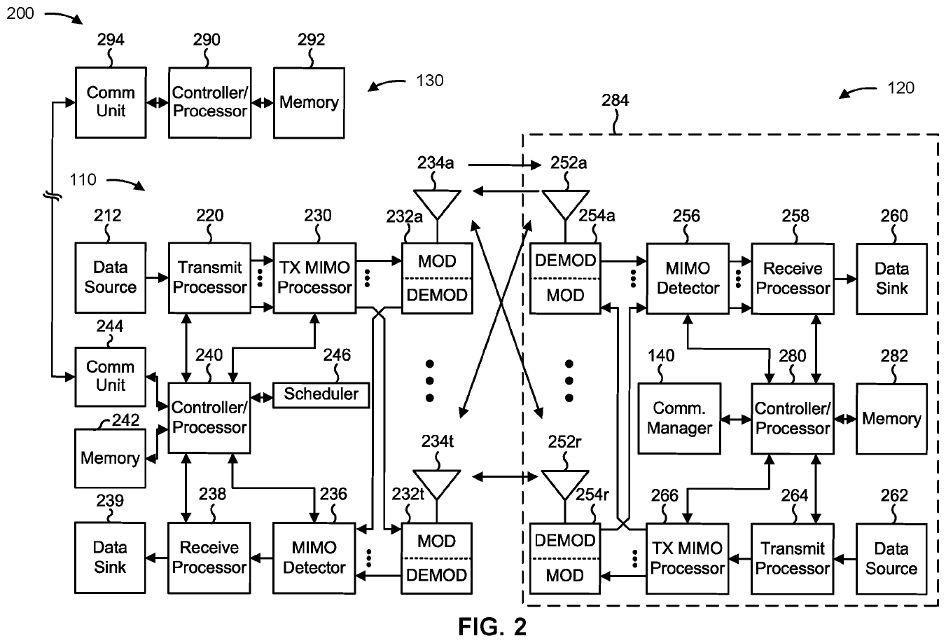

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)) A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

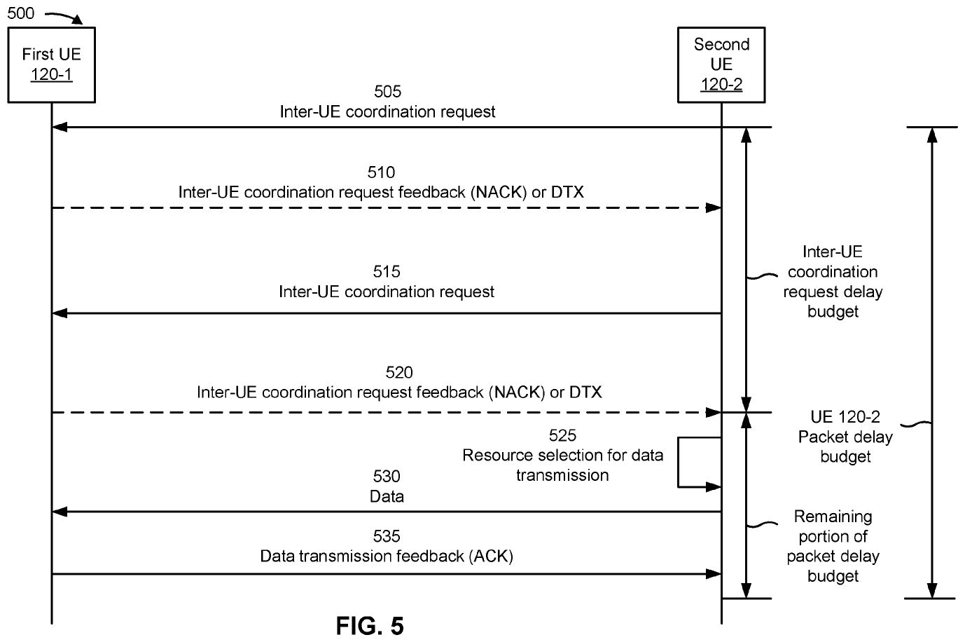

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-16).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-16).

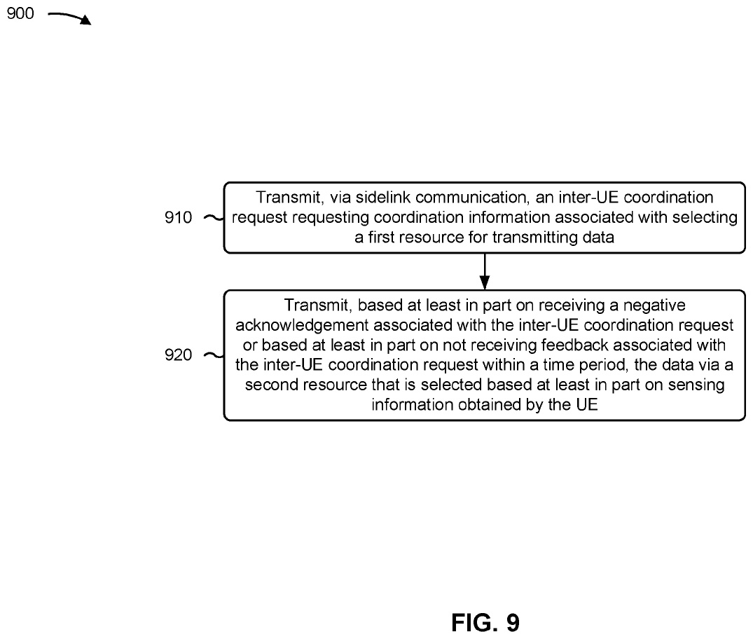

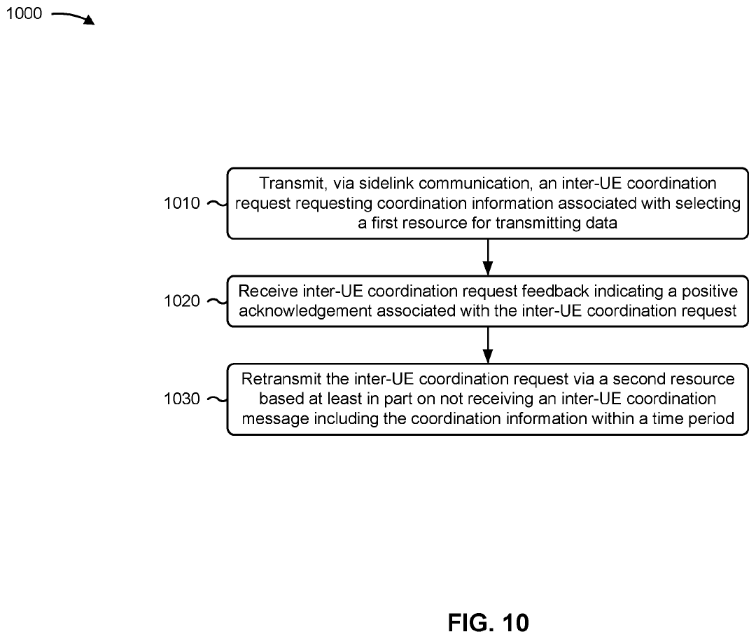

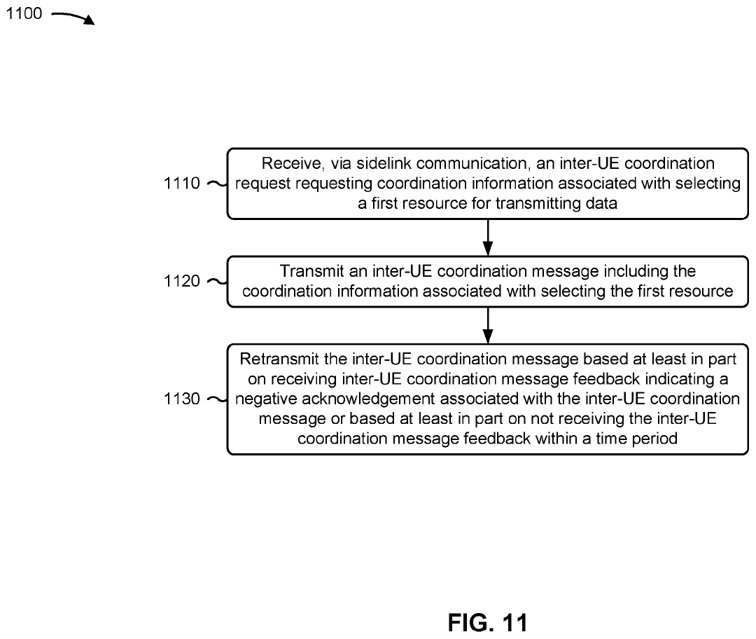

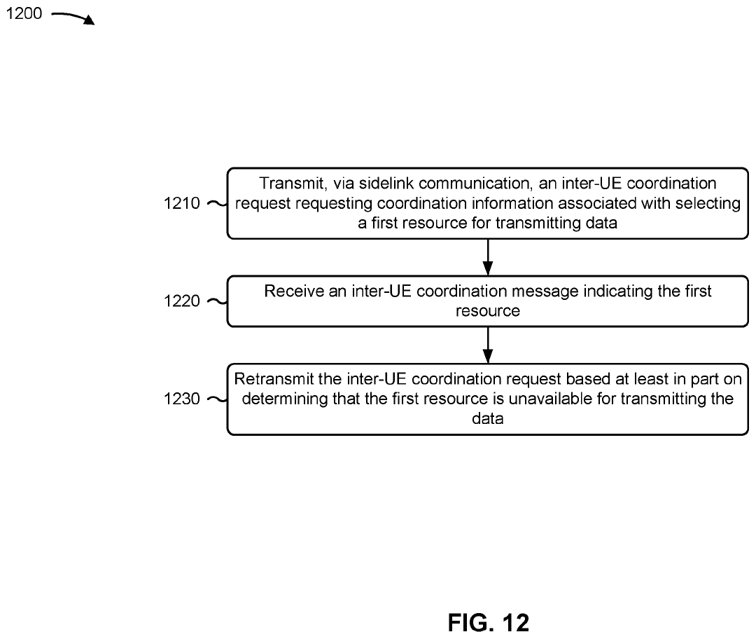

The controller/processor 240 of the base station 110, the controller/processor 280 of the UE 120, and/or any other component(s) of FIG. 2 may perform one or more techniques associated with feedback based inter-UE coordination message request and response, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE includes means for transmitting, via sidelink communication, an inter-UE coordination request requesting coordination information associated with selecting a first resource for transmitting data; and/or means for transmitting, based at least in part on receiving a negative acknowledgement associated with the inter-UE coordination request or based at least in part on not receiving feedback associated with the inter-UE coordination request within a time period, the data via a second resource that is selected based at least in part on sensing information obtained by the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for transmitting, via sidelink communication, an inter-UE coordination request requesting coordination information associated with selecting a first resource for transmitting data; means for receiving inter-UE coordination request feedback indicating a positive acknowledgement associated with the inter-UE coordination request; and/or means for retransmitting the inter-UE coordination request via a second resource based at least in part on not receiving an inter-UE coordination message including the coordination information within a time period. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving, via sidelink communication, an inter-UE coordination request requesting coordination information associated with selecting a first resource for transmitting data; means for transmitting an inter-UE coordination message including the coordination information associated with selecting the first resource; and/or means for retransmitting the inter-UE coordination message based at least in part on receiving inter-UE coordination message feedback indicating a negative acknowledgement associated with the inter-UE coordination message or based at least in part on not receiving the inter-UE coordination message feedback within a time period. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for transmitting, via sidelink communication, an inter-UE coordination request requesting coordination information associated with selecting a first resource for transmitting data; means for receiving an inter-UE coordination message indicating the first resource; and/or means for retransmitting the inter-UE coordination request based at least in part on determining that the first resource is unavailable for transmitting the data. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

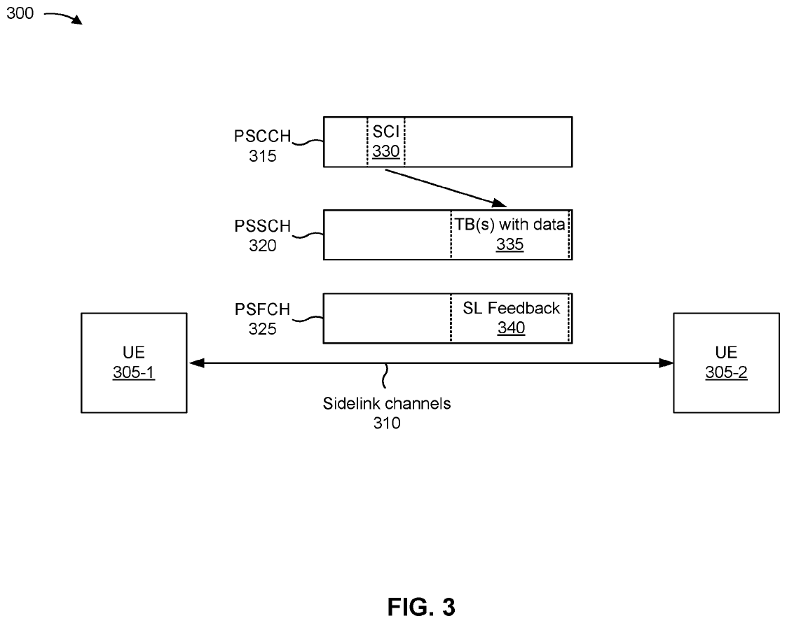

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., positive acknowledgement (ACK) or negative acknowledgement (NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

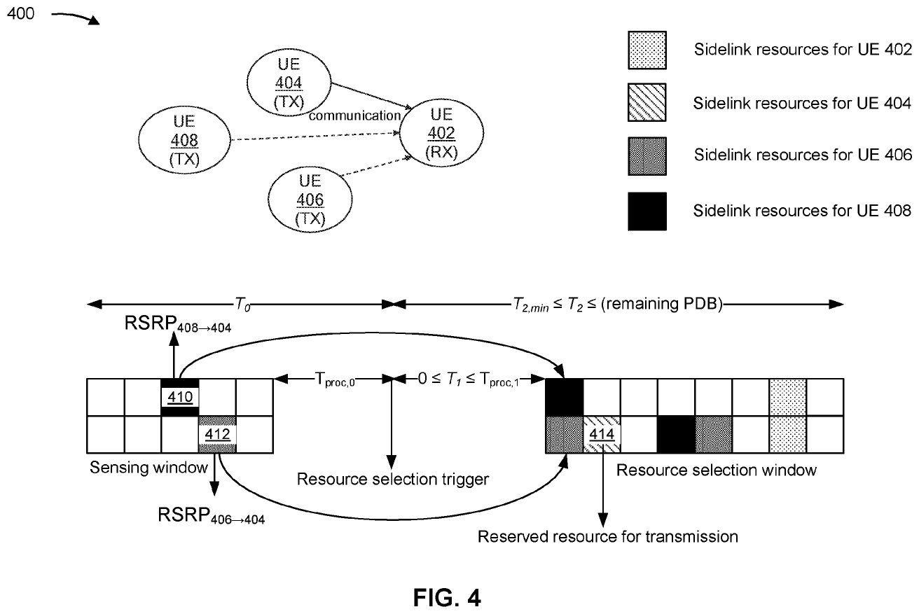

FIG. 4 is a diagram illustrating an example 400 of selecting sidelink resources, in accordance with the present disclosure. Example 400 shows a UE 402 (e.g., UE 305-1) that may receive communications on a sidelink channel from other UEs (e.g., a UE 305-2), such as UE 404, UE 406, and/or UE 408, as shown in FIG. 4.

As shown in FIG. 4, UE 404 is a transmitting UE that is transmitting communications to UE 402, which is a receiving UE. If UE 404 is to transmit a communication to UE 402, UE 404 may sense the sidelink channel in a sensing window to determine which sidelink resources (e.g., subcarriers, subchannels) are available. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured per transmission priority and receive priority pair. UE 404 may measure DMRSs on a PSCCH or a PSSCH, according to a configuration.

For example, UE 404 may prepare to transmit a communication to UE 402. UE 404 may have already sensed previous sidelink resources and successfully decoded SCI from UE 406 and UE 408. UE 404 may try to reserve sidelink resources, and thus may check the availability of the future sidelink resources reserved by UE 406 and UE 408 by sensing the sidelink channel in the sensing window. UE 404 may measure an RSRP of a signal from UE 408 in sidelink resource 410, and an RSRP of a signal from UE 406 in sidelink resource 412. If an observed RSRP satisfies the RSRP threshold (e.g., is lower than a maximum RSRP), the corresponding sidelink resource may be available for reservations by UE 404. UE 404 may reserve the sidelink resource (which may be a random selection from available resources). For example, UE 404 may select and reserve sidelink resource 414 for transmission. This may be in a time slot after which UE 406 and UE 408 had used sidelink resources, and UE 404 may have sensed these sidelink resources earlier.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB). T₀ shown in FIG. 4, may be a configured value, such as 100 milliseconds (ms) or 1100 ms. T₁ may be a time duration that is specific to a UE's implementation. T_{2,min} may be configured per priority {1, 5, 10, 20} times 2^{μ}, where μ=0, 1, 2, and 3 for subcarrier spacing of 15 kilohertz (kHz), 30 kHz, 60 kHz, and 120 kHz, respectively.

If resource selection is triggered, UE 404 may use SCIs detected during the sensing window. If another UE (e.g., 406, 408) is reserving a resource in the resource selection window, UE 404 may compare a measured RSRP from the other UE and compare it against an RSRP threshold. For example, UE 404 may compare the measured RSRP from the other UE against an RSRP threshold given for a pair of priorities (pᵢ, pⱼ), where pᵢ is the priority of the packet for which UE 404 is reserving a resource, and pⱼ is the priority of the packet of the other UE. If the measured RSRP is below the threshold, UE 404 may determine that the resource is available for transmitting the communication to UE 402.

In some cases, prior to selecting the resource and/or transmitting the communication to UE 402, the UE 404 may request coordination information to assist UE 404 in selecting the resource. For example, UE 404 may transmit an inter-UE coordination request to the UE 402. The UE 402 may receive the inter-UE coordination request and may generate an inter-UE coordination message that includes scheme 1 coordination information. The scheme 1 coordination information may indicate a preferred resource for the transmission of the communication (e.g., Type A coordination information) or a non-preferred resource for the transmission of the communication (e.g., Type B coordination information).

In some cases, the inter-UE coordination message may be a self-contained inter-UE coordination message. A self-contained inter-UE coordination message may be an inter-UE coordination message that is transmitted separate from a data transmission (rather than multiplexed with a data transmission). The UE 402 may perform a resource sensing and selection procedure similar to that described above.

In some cases, feedback may be configured for the inter-UE coordination request and the inter-UE coordination message. For example, the UE 402 may transmit inter-UE coordination request feedback indicating an ACK or a NACK associated with receiving the inter-UE coordination request to the UE 404. Similarly, the UE 404 may transmit inter-UE coordination message feedback indicating an ACK or a NACK associated with receiving the inter-UE coordination message to the UE 402.

In some cases, an inter-UE coordination message request and response failure may occur. For example, the UE 402 may transmit inter-UE coordination request feedback indicating an ACK associated with receiving the inter-UE coordination request to the UE 404. The UE 402 may perform a resource selection process for the UE 404 and may transmit an inter-UE coordination message to the UE 404. However, the UE 404 may not receive the inter-UE coordination message transmitted by the UE 402, may receive the inter-UE coordination message after expiration of a packet delay budget (PDB) associated with a data transmission, or may receive the inter-UE coordination message at a time when a remaining portion of the PDB is insufficient for processing the inter-UE coordination message, selecting a resource for the data transmission, and transmitting the data (including any subsequent retransmissions of the data) prior to the expiration of the PDB.

Some techniques and apparatuses described herein may relate to a recovering procedure for inter-UE coordination message request and response failure.

As indicated above, FIG. 4 is provided as an example. Other examples may differ from what is described with regard to FIG. 4.

FIG. 5 is a diagram illustrating an example 500 associated with a recovering procedure for inter-UE coordination message request and response failure, in accordance with the present disclosure. As shown in FIG. 5, example 500 includes communication between a first UE 120-1 and a second UE 120-2. In some aspects, the first UE 120-1 and the second UE 120-2 may be included in a wireless network, such as wireless network 100. The first UE 120-1 and the second UE 120-2 may communicate via sidelink communications, as described elsewhere herein.

As shown by reference number 505, the second UE 120-2 may transmit, and the first UE 120-1 may receive, a self-contained inter-UE coordination request. The self-contained inter-UE coordination request may indicate a set of requirements associated with the second UE 120-2 transmitting a data packet to another UE (e.g., the first UE 120-1 or one or more other UEs) via sidelink communications. For example, the self-contained inter-UE coordination request may indicate a size of the data packet, a priority associated with the data packet, or the UE to which the data packet is to be transmitted, among other examples.

In some aspects, the self-contained inter-UE coordination request may indicate that the first UE 120-1 is to provide scheme 1 coordination information (e.g., an indication of a set of preferred resources to be utilized by the second UE 120-2 for transmitting a communication and/or an indication of a set of non-preferred resources) to the second UE 120-2. The second UE 120-2 may utilize the coordination information to assist the second UE 120-2 in selecting one or more resources for transmitting the data packet (e.g., to the first UE 120-1 or one or more other UEs).

In some aspects, the self-contained inter-UE coordination request may indicate a set of available resources. The second UE 120-2 may perform a resource selection process to identify one or more sidelink resources that are available for transmitting the data. In some aspects, the second UE 120-2 may identify the one or more resources based at least in part on sensing information obtained by the second UE 120-2. For example, the second UE 120-2 may sense a sidelink channel in a sensing window and may identify one or more sidelink resources within a resource selection window that are available for the second UE 120-2 to transmit the data, as described elsewhere herein.

In some aspects, the self-contained inter-UE coordination request indicates all of the available resources identified by the second UE 120-2. In some aspects, the self-contained inter-UE coordination request indicates a set of preferred resources, of the available resources identified by the second UE 120-2. In some aspects, the self-contained inter-UE coordination request indicates a set of non-preferred resources, of the available resources identified by the second UE 120-2.

In some aspects, the self-contained inter-UE coordination request may request inter-UE coordination request feedback indicating a positive acknowledgement associated with receiving the self-contained inter-UE coordination request or a negative acknowledgement associated with receiving the self-contained inter-UE coordination request.

In some aspects, the self-contained inter-UE coordination request may indicate an inter-UE coordination request delay budget associated with the second UE 120-2 receiving inter-UE coordination request feedback from the first UE 120-1, as described in greater detail elsewhere herein.

In some aspects, the second UE 120-2 may transmit the self-contained inter-UE coordination request via a reserved sidelink resource. For example, prior to transmitting the self-contained inter-UE coordination request, the second UE 120-2 may transmit SCI reserving a set of resources for transmitting the self-contained inter-UE coordination request. In some aspects, the SCI may reserve a set of sidelink resources for at least one retransmission of the self-contained inter-UE coordination request, as described in greater detail elsewhere herein.

As shown by reference number 510, the first UE 120-1 may transmit, and the second UE 120-2 may receive, inter-UE coordination request feedback associated with the self-contained inter-UE coordination request. In some aspects, the first UE 120-1 may determine that the self-contained inter-UE coordination request corresponds to a transmission of a data packet. The first UE 120-1 may determine to transmit the inter-UE coordination request feedback based at least in part on the self-contained inter-UE coordination request corresponding to a transmission of a data packet. For example, the first UE 120-1 may transmit HARQ feedback corresponding to the inter-UE coordination request feedback via a PSFCH, in a manner similar to that described elsewhere herein.

In some aspects, the inter-UE coordination request feedback may indicate an ACK, as described elsewhere herein. In some aspects, as shown in FIG. 5, the inter-UE coordination request feedback may indicate a NACK. For example, the first UE 120-1 may transmit inter-UE coordination request feedback indicating a NACK based at least in part on being unable to successfully decode the self-contained inter-UE coordination request.

In some aspects, as also shown in FIG. 5, the first UE 120-1 may not transmit the inter-UE coordination request feedback or the second UE 120-2 may not receive the inter-UE coordination request feedback (indicated in FIG. 5 as a discontinuous transmission (DTX)). For example, the first UE 120-1 may not receive the self-contained inter-UE coordination request from the second UE 120-2 and, therefore, may not transmit any feedback associated with the self-contained inter-UE coordination request to the second UE 120-2.

As shown by reference number 515, the second UE 120-2 may retransmit the self-contained inter-UE coordination request to the first UE 120-1. In some aspects, the second UE 120-2 may retransmit the self-contained inter-UE coordination request based at least in part on receiving the inter-UE coordination request feedback indicating the NACK. In some aspects, the second UE 120-2 may retransmit the self-contained inter-UE coordination request based at least in part on not receiving the inter-UE coordination request feedback within a time period.

In some aspects, the second UE 120-2 may retransmit the self-contained inter-UE coordination request via a reserved sidelink resource. For example, prior to the initial transmission of the self-contained inter-UE coordination request, the second UE 120-2 may transmit SCI reserving a set of resources for transmitting the self-contained inter-UE coordination request and at least one retransmission of the self-contained inter-UE coordination request.

In some aspects, the inter-UE coordination request may not be retransmitted by the second UE 120-2. For example, the second UE 120-2 may determine not to retransmit the self-contained inter-UE coordination request based at least in part on a latency or a level of interference associated with retransmitting the inter-UE coordination request.

As shown by reference number 520, the first UE 120-1 may transmit, and the second UE 120-2 may receive, inter-UE coordination request feedback associated with the retransmission of the self-contained inter-UE coordination request. In some aspects, the first UE 120-1 may transmit the inter-UE coordination request in a manner similar to that described elsewhere herein.

In some aspects, the inter-UE coordination request feedback may indicate an ACK, as described elsewhere herein. In some aspects, as shown in FIG. 5, the inter-UE coordination request feedback may indicate a NACK. For example, the first UE 120-1 may transmit inter-UE coordination request feedback indicating a NACK based at least in part on being unable to successfully decode the retransmission of the self-contained inter-UE coordination request.

In some aspects, as also shown in FIG. 5, the first UE 120-1 may not transmit the inter-UE coordination request feedback (indicated in FIG. 5 as DTX), and, therefore, the second UE 120-2 may not receive the inter-UE coordination request feedback prior to an expiration of an inter-UE coordination request delay budget.

In some aspects, the inter-UE coordination request delay budget may correspond to a timeline configuration indication provided by an upper layer of the UE to a physical (PHY) layer of the UE. The inter-UE coordination request delay budget may enable a latency associated with selecting or reserving a resource for transmitting the data to satisfy a condition associated with a packet delay budget (PDB) associated with transmitting the data.

In some aspects, the condition may be satisfied when an amount of time associated with selecting the second resource, reserving the second resource, transmitting the data, and retransmitting the data is less than a remaining portion of the PDB. For example, the inter-UE coordination request delay budget may be configured such that, upon expiration of the inter-UE coordination request delay budget, a remaining portion of the PDB for the data transmission is less than an amount of time required for the second UE 120-2 to select a resource for transmitting the data based at least in part on sensing information obtained by the second UE 120-2, reserve the selected resource, transmit the data on the reserved resource, and retransmit the data prior to the expiration of the PDB associated with the data transmission.

As shown by reference number 525, the second UE 120-2 may perform a resource selection process to select a resource for the data transmission. In some aspects, the second UE 120-2 may select the resource based at least in part on sensing information obtained by the second UE 120-2. For example, the second UE 120-2 may sense a sidelink channel in a sensing window and may select one or more sidelink resources within a resource selection window that are available for the second UE 120-2 to transmit the data, as described elsewhere herein.

In some aspects, the second UE 120-2 may transmit the data to one or more UEs via the selected sidelink resources. In some aspects, the second UE 120-2 may multi-cast the data to a group of UEs. In some aspects, the group of UEs may include the first UE 120-1. In some aspects, the first UE 120-1 may not be included in the group of UEs.

In some aspects, the second UE 120-2 may unicast the data to a single UE. For example, the second UE 120-2 may transmit the data to the first UE 120-1 or another UE via the selected sidelink resources. As shown by reference number 530, the second UE 120-2 may transmit the data to the first UE 120-1 via the selected sidelink resources.

As shown by reference number 535, the first UE 120-1 may transmit, and the second UE 120-2 may receive, feedback associated with the transmitted data. In some aspects, the first UE 120-1 may transmit the feedback associated with the transmitted data in a manner similar to that described elsewhere herein with respect to the inter-UE coordination request feedback or the inter-UE coordination response feedback.

The feedback may indicate whether the first UE 120-1 successfully received and decoded the transmitted data. For example, as shown in FIG. 5, the first UE 120-1 may transmit an ACK to the second UE 120-2 based at least in part on the first UE 120-1 successfully receiving and decoding the data transmitted by the second UE 120-2.

As indicated above, FIG. 5 is provided as an example. Other examples may differ from what is described with respect to FIG. 5.

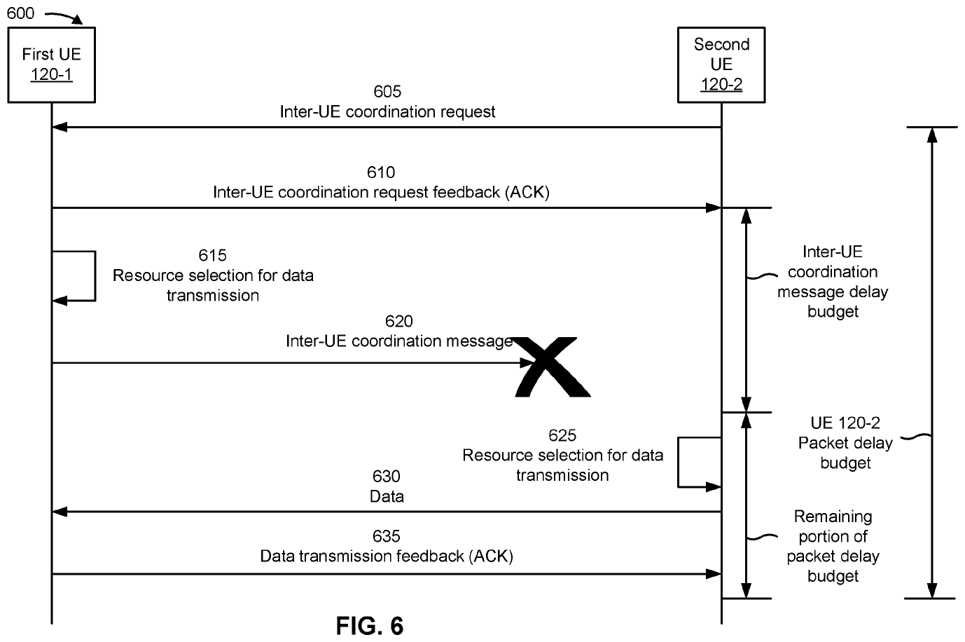

FIG. 6 is a diagram illustrating an example 600 associated with feedback based inter-UE coordination message request and response, in accordance with the present disclosure. As shown in FIG. 6, example 600 includes communication between a first UE 120-1 and a second UE 120-2. In some aspects, the first UE 120-1 and the second UE 120-2 may be included in a wireless network, such as wireless network 100. The first UE 120-1 and the second UE 120-2 may communicate via sidelink communications, as described elsewhere herein.

As shown by reference number 605, the second UE 120-2 may transmit a self-contained inter-UE coordination request to the first UE 120-1. The self-contained inter-UE coordination request may indicate a set of requirements associated with the second UE 120-2 transmitting a data packet to another UE (e.g., the first UE 120-1 or one or more other UEs) via sidelink communications. For example, the self-contained inter-UE coordination request may indicate a size of the data packet, a priority associated with the data packet, or the UE to which the data packet is to be transmitted, among other examples.

In some aspects, the self-contained inter-UE coordination request may indicate that the first UE 120-1 is to provide scheme 1 coordination information (e.g., an indication of a set of preferred resources to be utilized by the second UE 120-2 for transmitting a communication and/or an indication of a set of non-preferred resources) to the second UE 120-2. The second UE 120-2 may utilize the coordination information to assist the second UE 120-2 in selecting one or more resources for transmitting the data packet (e.g., to the first UE 120-1 or one or more other UEs).

In some aspects, the self-contained inter-UE coordination request may indicate a set of available resources. The second UE 120-2 may perform a resource selection process to identify one or more sidelink resources that are available for transmitting the data. In some aspects, the second UE 120-2 may identify the one or more resources based at least in part on sensing information obtained by the second UE 120-2. For example, the second UE 120-2 may sense a sidelink channel in a sensing window and may identify one or more sidelink resources within a resource selection window that are available for the second UE 120-2 to transmit the data, as described elsewhere herein.

In some aspects, the self-contained inter-UE coordination request indicates all of the available resources identified by the second UE 120-2. In some aspects, the self-contained inter-UE coordination request indicates a set of preferred resources, of the available resources identified by the second UE 120-2. In some aspects, the self-contained inter-UE coordination request indicates a set of non-preferred resources, of the available resources identified by the second UE 120-2.

In some aspects, the self-contained inter-UE coordination request may request inter-UE coordination request feedback indicating a positive acknowledgement associated with receiving the self-contained inter-UE coordination request or a negative acknowledgement associated with receiving the self-contained inter-UE coordination request.

In some aspects, the self-contained inter-UE coordination request may indicate an inter-UE coordination request delay budget associated with receiving inter-UE coordination request feedback from the first UE 120-1. In some aspects, the inter-UE coordination request may indicate an inter-UE coordination message delay budget associated with receiving an inter-UE coordination message from the first UE 120-1, as described in greater detail elsewhere herein.

In some aspects, the second UE 120-2 may transmit the self-contained inter-UE coordination request via a reserved sidelink resource. For example, prior to transmitting the self-contained inter-UE coordination request, the second UE 120-2 may transmit SCI reserving a set of resources for transmitting the self-contained inter-UE coordination request. In some aspects, the SCI may reserve a set of sidelink resources for at least one retransmission of the self-contained inter-UE coordination request message, as described elsewhere herein.

As shown by reference number 610, the first UE 120-1 may transmit, and the second UE 120-2 may receive, inter-UE coordination request feedback associated with the self-contained inter-UE coordination request. In some aspects, the second UE 120-2 may receive the inter-UE coordination request feedback via a PSFCH in a manner similar to that described elsewhere herein.

In some aspects, the inter-UE coordination request feedback may indicate a NACK, as described elsewhere herein. In some aspects, as shown in FIG. 6, the inter-UE coordination request feedback may indicate an ACK. For example, the first UE 120-1 may transmit inter-UE coordination request feedback indicating an ACK based at least in part on successfully receiving and decoding the self-contained inter-UE coordination request.

As shown by reference number 615, the first UE 120-1 may perform a resource selection process to select one or more sidelink resources for the second UE 120-2 based at least in part on the inter-UE coordination request. In some aspects, the first UE 120-1 may perform the resource selection process and may select the one or more sidelink resources for the second UE 120-2 based at least in part on sensing information obtained by the first UE 120-1, in a manner similar to that described elsewhere herein.

In some aspects, the second UE 120-2 may perform a resource selection process to select one or more sidelink resources based at least in part on sensing information obtained by the second UE 120-2, and may transmit the data via the selected sidelink resources, in a manner similar to that described elsewhere herein.

As shown by reference number 620, the first UE 120-1 may transmit a self-contained inter-UE coordination message. The self-contained inter-UE coordination message may include coordination information indicating the one or more sidelink resources selected by the first UE 120-1.

In some aspects, the self-contained inter-UE coordination message may indicate the set of available resources indicated in the self-contained inter-UE coordination request. The set of available resources may be associated with selection information. The selection information may indicate whether a resource, included in the set of available resources, is determined by the first UE 120-1 to be a preferred resource or a non-preferred resource.

As shown in FIG. 6, the second UE 120-2 may fail to receive the self-contained inter-UE coordination message or may fail to receive the self-contained inter-UE coordination message prior to the expiration of an inter-UE coordination message delay budget.

In some aspects, the inter-UE coordination message delay budget may correspond to a timeline configuration indication provided by an upper layer of the UE to a PHY layer of the UE. The inter-UE coordination message delay budget may enable a latency associated with selecting or reserving a resource for transmitting the data to satisfy a condition associated with a PDB associated with transmitting the data. In some aspects, as shown in FIG. 6, the inter-UE coordination message delay budget may begin based at least in part on the second UE 120-2 receiving the inter-UE coordination message feedback from the first UE 120-1. In some aspects, the inter-UE coordination message delay budget may expire at a time corresponding to a time at which the condition associated with the PDB is no longer satisfied.

In some aspects, the condition may no longer be satisfied when an amount of time associated with selecting the second resource, reserving the second resource, transmitting the data, and retransmitting the data is greater than a remaining portion of the PDB. For example, the inter-UE coordination message delay budget may be configured such that, upon expiration of the inter-UE coordination message delay budget, a remaining portion of the PDB for the data transmission is less than an amount of time required for the second UE 120-2 to select a resource for transmitting the data based at least in part on sensing information obtained by the second UE 120-2, reserve the selected resource, transmit the data on the reserved resource, and retransmit the data prior to the expiration of the PDB associated with the data transmission.

In some aspects, a time interval corresponding to the inter-UE coordination message delay budget may be less than a time interval corresponding to the inter-UE coordination request delay budget. In some aspects, the time interval corresponding to the inter-UE coordination message delay budget may be equal to the time interval corresponding to the inter-UE coordination request delay budget.

As shown by reference number 625, the second UE 120-2 may perform a resource selection process to select one or more sidelink resources based at least in part on failing to receive the self-contained inter-UE coordination message or receiving the self-contained inter-UE coordination message after expiration of the inter-UE coordination message delay budget. In some aspects, the second UE 120-2 may select the resource based at least in part on sensing information obtained by the second UE 120-2. For example, the second UE 120-2 may sense a sidelink channel in a sensing window and may select one or more sidelink resources within a resource selection window that are available for the second UE 120-2 to transmit the data, as described elsewhere herein.

In some aspects, the second UE 120-2 may transmit the data to one or more UEs via the selected sidelink resources. In some aspects, the second UE 120-2 may multi-cast the data to a group of UEs. In some aspects, the group of UEs may include the first UE 120-1. In some aspects, the first UE 120-1 may not be included in the group of UEs.

In some aspects, the second UE 120-2 may unicast the data to a single UE. For example, the second UE 120-2 may transmit the data to the first UE 120-1 or another UE via the selected sidelink resources. As shown by reference number 630, the second UE 120-2 may transmit the data to the first UE 120-1 via the selected sidelink resources.

As shown by reference number 635, the first UE 120-1 may transmit, and the second UE 120-2 may receive, feedback associated with the transmitted data. In some aspects, the first UE 120-1 may transmit the feedback associated with the transmitted data in a manner similar to that described elsewhere herein with respect to the inter-UE coordination request feedback or the inter-UE coordination response feedback.

The feedback may indicate whether the first UE 120-1 successfully received and decoded the transmitted data. For example, as shown in FIG. 6, the first UE 120-1 may transmit an ACK to the second UE 120-2 based at least in part on the first UE 120-1 successfully receiving and decoding the data transmitted by the second UE 120-2.

As indicated above, FIG. 6 is provided as an example. Other examples may differ from what is described with respect to FIG. 6.

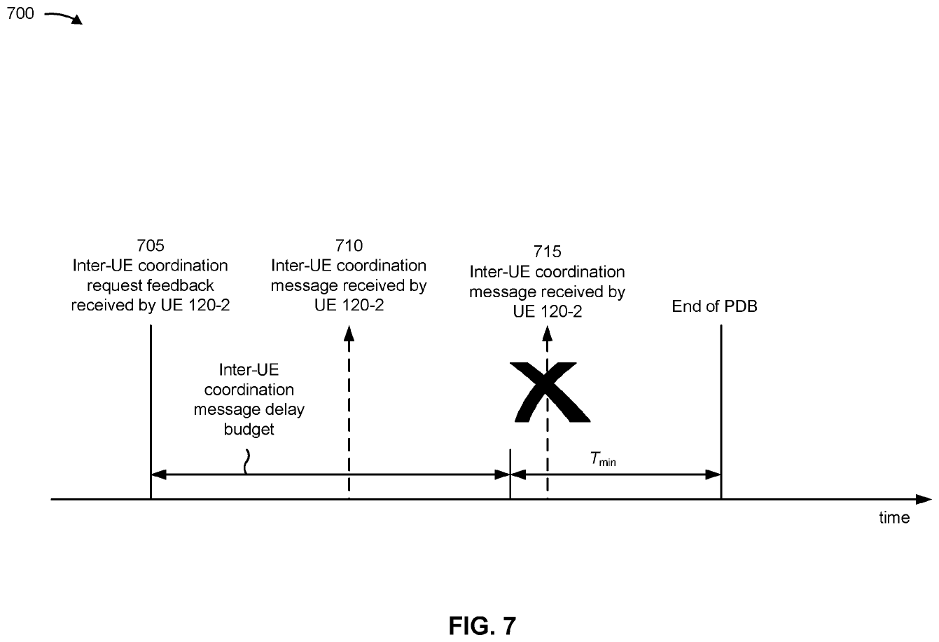

FIG. 7 is a diagram illustrating an example 700 associated with feedback based inter-UE coordination message request and response, in accordance with the present disclosure. As shown in FIG. 7, example 700 may illustrate a timeline associated with a UE (e.g., the second UE 120-2) utilizing coordination information included in a self-contained inter-UE coordination message (e.g., a self-contained inter-UE coordination message received from the first UE 120-1).

In some aspects, the second UE 120-2 may receive a configuration associated with utilizing coordination information included in a self-contained inter-UE coordination message. In some aspects, the configuration is pre-configured. In some aspects, the configuration is determined by an upper layer of the second UE 120-2 and provided to a PHY layer of the second UE 120-2. The configuration may indicate a PDB associated with a data transmission, an inter-UE coordination message delay budget, and a time interval Tₘᵢₙ. As shown in FIG. 7, time interval Tₘᵢₙ may extend from an end of the inter-UE coordination message delay budget to an end of the PDB. The time interval Tₘᵢₙ may be configured such that, upon expiration of the inter-UE coordination message delay budget, a remaining portion of the PDB is less than an amount of time required for the second UE 120-2 to select a resource for transmitting the data based at least in part on sensing information obtained by the second UE 120-2, reserve the selected resource, and transmit the data (including any retransmissions of the data that may be necessary) prior to the expiration of the PDB.

As shown by reference number 705, a start of an inter-UE coordination message delay budget may correspond to a time at which the second UE 120-2 receives inter-UE coordination message feedback from the first UE 120-1. The second UE 120-2 may receive the inter-UE coordination message feedback in a manner similar to that described elsewhere herein.

In some aspects, as shown by reference number 710, the second UE 120-2 may receive the self-contained inter-UE coordination message prior to the expiration of the inter-UE coordination message delay budget. The second UE 120-2 may utilize coordination information included in the self-contained inter-UE coordination message to select one or more resources for transmitting the data based at least in part on receiving the self-contained inter-UE coordination message prior to the expiration of the inter-UE coordination message delay budget.

In some aspects, as shown by reference number 715, the second UE 120-2 may receive the self-contained inter-UE coordination message after the expiration of the inter-UE coordination message delay budget. The second UE 120-2 may determine not to use the coordination information included in the self-contained inter-UE coordination message to select the resource for transmitting the data based at least in part on receiving the self-contained inter-UE coordination message after the expiration of the inter-UE coordination message delay budget. The second UE 120-2 may utilize sensing information obtained by the second UE 120-2 to select the resource for transmitting the data based at least in part on determining not to utilize the coordination information included in the self-contained inter-UE coordination message or based at least in part on determining an expiration of the inter-UE coordination message delay budget prior to receiving the self-contained inter-UE coordination message.

As indicated above, FIG. 7 is provided as an example. Other examples may differ from what is described with respect to FIG. 7.

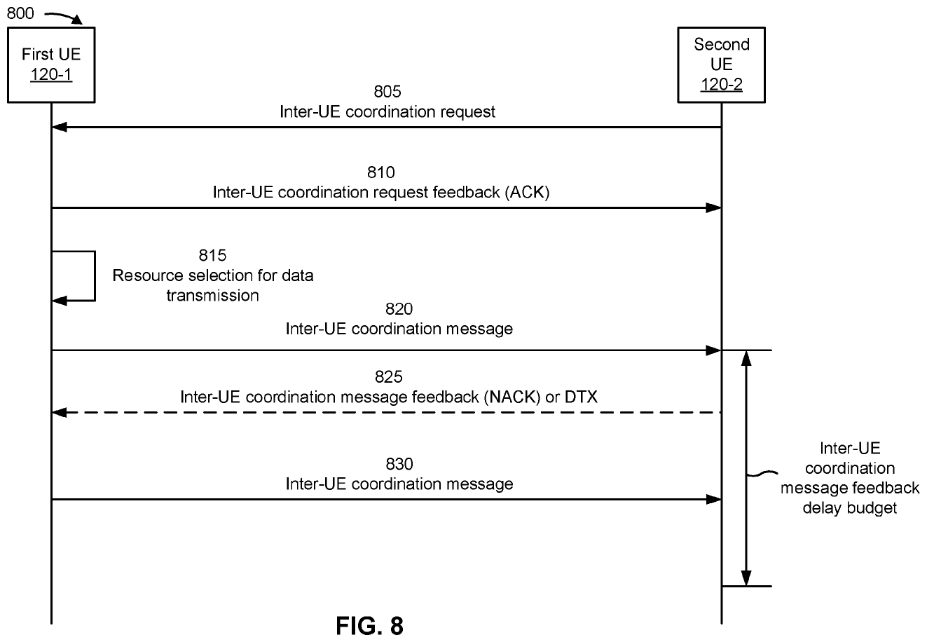

FIG. 8 is a diagram illustrating an example 800 associated with feedback based inter-UE coordination message request and response, in accordance with the present disclosure. As shown in FIG. 8, example 800 includes communication between a first UE 120-1 and a second UE 120-2. In some aspects, the first UE 120-1 and the second UE 120-2 may be included in a wireless network, such as wireless network 100. The first UE 120-1 and the second UE 120-2 may communicate via sidelink communications, as described elsewhere herein.

As shown by reference number 805, the second UE 120-2 may transmit a self-contained inter-UE coordination request to the first UE 120-1. The self-contained inter-UE coordination request may indicate a set of requirements associated with the second UE 120-2 transmitting a data packet to another UE (e.g., the first UE 120-1 or one or more other UEs) via sidelink communications. For example, the self-contained inter-UE coordination request may indicate a size of the data packet, a priority associated with the data packet, or the UE to which the data packet is to be transmitted, among other examples.

In some aspects, the self-contained inter-UE coordination request may indicate that the first UE 120-1 is to provide scheme 1 coordination information (e.g., an indication of a set of preferred resources to be utilized by the second UE 120-2 for transmitting a communication and/or an indication of a set of non-preferred resources) to the second UE 120-2. The second UE 120-2 may utilize the coordination information to assist the second UE 120-2 in selecting one or more resources for transmitting the data packet (e.g., to the first UE 120-1 or one or more other UEs).

In some aspects, the self-contained inter-UE coordination request may request inter-UE coordination request feedback indicating a positive acknowledgement associated with receiving the self-contained inter-UE coordination request or a negative acknowledgement associated with receiving the self-contained inter-UE coordination request.

In some aspects, the inter-UE coordination request may indicate an inter-UE coordination request delay budget and/or an inter-UE coordination message delay budget associated with receiving an inter-UE coordination request and/or the inter-UE coordination message, respectively, from the first UE 120-1, as described elsewhere herein.

In some aspects, the second UE 120-2 may transmit the self-contained inter-UE coordination request via a reserved sidelink resource. For example, prior to transmitting the self-contained inter-UE coordination request, the second UE 120-2 may transmit SCI reserving a set of resources for transmitting the self-contained inter-UE coordination request. In some aspects, the SCI may reserve a set of sidelink resources for at least one retransmission of the self-contained inter-UE coordination request message, as described elsewhere herein.

As shown by reference number 810, the first UE 120-1 may transmit, and the second UE 120-2 may receive, inter-UE coordination request feedback associated with the self-contained inter-UE coordination request. In some aspects, the second UE 120-2 may receive the inter-UE coordination request feedback via a PSFCH in a manner similar to that described elsewhere herein.

In some aspects, the inter-UE coordination request feedback may indicate a NACK, as described elsewhere herein. In some aspects, as shown in FIG. 8, the inter-UE coordination request feedback may indicate an ACK. For example, the first UE 120-1 may transmit inter-UE coordination request feedback indicating an ACK based at least in part on successfully receiving and decoding the self-contained inter-UE coordination request.

As shown by reference number 815, the first UE 120-1 may perform a resource selection process to select one or more sidelink resources for the second UE 120-2 based at least in part on the inter-UE coordination request. In some aspects, the first UE 120-1 may perform the resource selection process and may select the one or more sidelink resources for the second UE 120-2 based at least in part on sensing information obtained by the first UE 120-1, in a manner similar to that described elsewhere herein.

In some aspects, the second UE 120-2 may perform a resource selection process to select one or more sidelink resources based at least in part on sensing information obtained by the second UE 120-2 and may transmit the data via the selected sidelink resources, in a manner similar to that described elsewhere herein.

As shown by reference number 820, the first UE 120-1 may transmit a self-contained inter-UE coordination message. The self-contained inter-UE coordination message may include coordination information indicating the one or more sidelink resources selected by the first UE 120-1.

As shown by reference number 825, the second UE 120-2 may transmit inter-UE coordination message feedback to the first UE 120-1. In some aspects, the second UE 120-2 may determine that the self-contained inter-UE coordination message corresponds to a transmission of a data packet. The second UE 120-2 may determine to transmit the inter-UE coordination message feedback based at least in part on the self-contained inter-UE coordination message corresponding to a transmission of a data packet. For example, the second UE 120-2 may transmit HARQ feedback corresponding to the inter-UE coordination message feedback via a PSFCH, in a manner similar to that described elsewhere herein.

In some aspects, the inter-UE coordination message feedback may indicate an ACK, as described elsewhere herein. In some aspects, as shown in FIG. 8, the inter-UE coordination message feedback may indicate a NACK. For example, the second UE 120-2 may transmit inter-UE coordination message feedback indicating a NACK based at least in part on being unable to successfully decode the self-contained inter-UE coordination message.

In some aspects, as also shown in FIG. 8, the second UE 120-2 may not transmit the inter-UE coordination message feedback (indicated in FIG. 7 as DTX), and, therefore, the first UE 120-1 may not receive the inter-UE coordination message feedback. For example, the second UE 120-2 may not receive the self-contained inter-UE coordination message from the first UE 120-1 and, therefore, may not transmit any feedback associated with the self-contained inter-UE coordination message to the first UE 120-1.

As shown by reference number 830, the first UE 120-1 may retransmit the self-contained inter-UE coordination message to the second UE 120-2. In some aspects, the first UE 120-1 may retransmit the self-contained inter-UE coordination message based at least in part on receiving the inter-UE coordination message feedback indicating the NACK. In some aspects, the first UE 120-1 may retransmit the self-contained inter-UE coordination message based at least in part on not receiving the inter-UE coordination message feedback within a time period.

In some aspects, the first UE 120-1 may retransmit the self-contained inter-UE coordination message based at least in part on an inter-UE coordination message delay budget. For example, the self-contained inter-UE coordination request may indicate an inter-UE coordination message delay budget associated with the second UE 120-2 receiving the self-contained inter-UE coordination message. The first UE 120-1 may determine whether the inter-UE coordination message delay budget is expired. In some aspects, as shown in FIG. 8, the first UE 120-1 may retransmit the self-contained inter-UE coordination message to the second UE 120-2 when the inter-UE coordination message delay budget is not expired.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with a recovering procedure for inter-UE coordination message request and response failure.

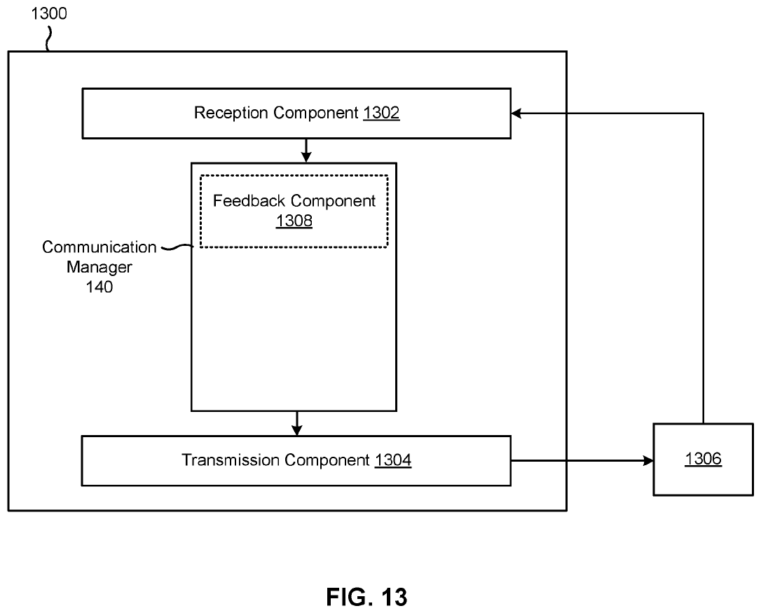

As shown in FIG. 9, in some aspects, process 900 may include transmitting, via sidelink communication, an inter-UE coordination request requesting coordination information associated with selecting a first resource for transmitting data (block 910). For example, the UE (e.g., using communication manager 140 and/or transmission component 1304, depicted in FIG. 13) may transmit, via sidelink communication, an inter-UE coordination request requesting coordination information associated with selecting a first resource for transmitting data, as described above.

As further shown in FIG. 9, in some aspects, process 900 may include transmitting, based at least in part on receiving a negative acknowledgement associated with the inter-UE coordination request or based at least in part on not receiving feedback associated with the inter-UE coordination request within a time period, the data via a second resource that is selected based at least in part on sensing information obtained by the UE (block 920). For example, the UE (e.g., using communication manager 140 and/or transmission component 1304, depicted in FIG. 13) may transmit, based at least in part on receiving a negative acknowledgement associated with the inter-UE coordination request or based at least in part on not receiving feedback associated with the inter-UE coordination request within a time period, the data via a second resource that is selected based at least in part on sensing information obtained by the UE, as described above.

Process 900 may include additional aspects, such as any single aspect or any combination of aspects described below and/or in connection with one or more other processes described elsewhere herein.

In a first aspect, process 900 includes retransmitting the inter-UE coordination request based at least in part on receiving the negative acknowledgement associated with the inter-UE coordination request or based at least in part on not receiving the feedback associated with the inter-UE coordination request within the time period, wherein the data is transmitted via the second resource based at least in part on receiving a negative acknowledgement associated with retransmitting the inter-UE coordination request or based at least in part on not receiving feedback associated with retransmitting the inter-UE coordination request within another time period.

In a second aspect, the inter-UE coordination request is retransmitted via a third resource, and the third resource is reserved prior to transmitting the inter-UE coordination request.

In a third aspect, the inter-UE coordination request is retransmitted via a third resource, and the third resource is selected by the UE based at least in part on receiving the negative acknowledgement associated with the inter-UE coordination request or based at least in part on not receiving the feedback associated with the inter-UE coordination request within the time period.

In a fourth aspect, the inter-UE coordination request is not retransmitted based at least in part on a latency or a level of interference associated with retransmitting the inter-UE coordination request.

In a fifth aspect, the time period corresponds to an inter-UE coordination request delay budget, wherein the feedback associated with the inter-UE coordination request is received after expiration of the time period, and wherein the data is transmitted via the second resource based at least in part on the feedback being received after the expiration of the time period.

In a sixth aspect, the inter-UE coordination request delay budget corresponds to a timeline configuration indication provided by an upper layer of the UE to a physical layer of the UE, and the inter-UE coordination request delay budget enables a latency associated with reserving the second resource to satisfy a condition associated with a packet delay budget associated with transmitting the data.

In a seventh aspect, the condition is satisfied when an amount of time associated with selecting the second resource, reserving the second resource, transmitting the data, and retransmitting the data is less than the packet delay budget.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with a recovering procedure for inter-UE coordination message request and response failure.

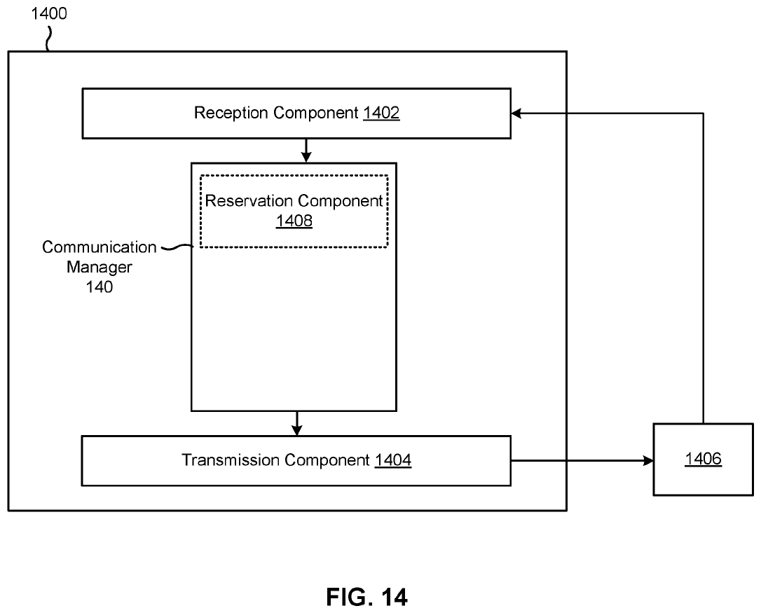

As shown in FIG. 10, in some aspects, process 1000 may include transmitting, via sidelink communication, an inter-UE coordination request requesting coordination information associated with selecting a first resource for transmitting data (block 1010). For example, the UE (e.g., using communication manager 140 and/or transmission component 1404, depicted in FIG. 14) may transmit, via sidelink communication, an inter-UE coordination request requesting coordination information associated with selecting a first resource for transmitting data, as described above.

As further shown in FIG. 10, in some aspects, process 1000 may include receiving inter-UE coordination request feedback indicating a positive acknowledgement associated with the inter-UE coordination request (block 1020). For example, the UE (e.g., using communication manager 140 and/or reception component 1402, depicted in FIG. 14) may receive inter-UE coordination request feedback indicating a positive acknowledgement associated with the inter-UE coordination request, as described above.

As further shown in FIG. 10, in some aspects, process 1000 may include retransmitting the inter-UE coordination request via a second resource based at least in part on not receiving an inter-UE coordination message including the coordination information within a time period (block 1030). For example, the UE (e.g., using communication manager 140 and/or transmission component 1404, depicted in FIG. 14) may retransmit the inter-UE coordination request via a second resource based at least in part on not receiving an inter-UE coordination message including the coordination information within a time period, as described above.

Process 1000 may include additional aspects, such as any single aspect or any combination of aspects described below and/or in connection with one or more other processes described elsewhere herein.

In a first aspect, process 1000 includes reserving the second resource prior to transmitting the inter-UE coordination request.

In a second aspect, the second resource is reserved based at least in part on not receiving the inter-UE coordination message including the coordination information within the time period.

In a third aspect, process 1000 includes transmitting data via a third resource based at least in part on not receiving the inter-UE coordination message including the coordination information within another time period, wherein the third resource is selected based at least in part on sensing information obtained by the UE, wherein the other time period corresponds to an inter-UE coordination response delay budget associated with receiving the inter-UE coordination message, and wherein the inter-UE coordination response delay budget is less than a packet delay budget associated with transmitting the data.

In a fourth aspect, process 1000 includes receiving the inter-UE coordination message after an expiration of the other time period, wherein the data is transmitted via the third resource based at least in part on the inter-UE coordination message being received after the expiration of the other time period.

In a fifth aspect, the inter-UE coordination response delay budget corresponds to a timeline configuration indication provided by an upper layer of the UE to a physical layer of the UE, and the inter-UE coordination response delay budget enables a latency associated with reserving the second resource to satisfy a condition associated with a packet delay budget associated with transmitting the data.

In a sixth aspect, the condition is satisfied when an amount of time associated with selecting the third resource, reserving the third resource, transmitting the data, and retransmitting the data is less than the packet delay budget.

In a seventh aspect, the condition is satisfied when a remaining portion of the inter-UE coordination packet delay budget is less than, or equal to, a minimum time interval, wherein the minimum time interval is preconfigured or configured by an upper layer of the UE, and wherein the inter-UE coordination request indicates one or more of the time period or the other time period.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with a recovering procedure for inter-UE coordination message request and response failure.

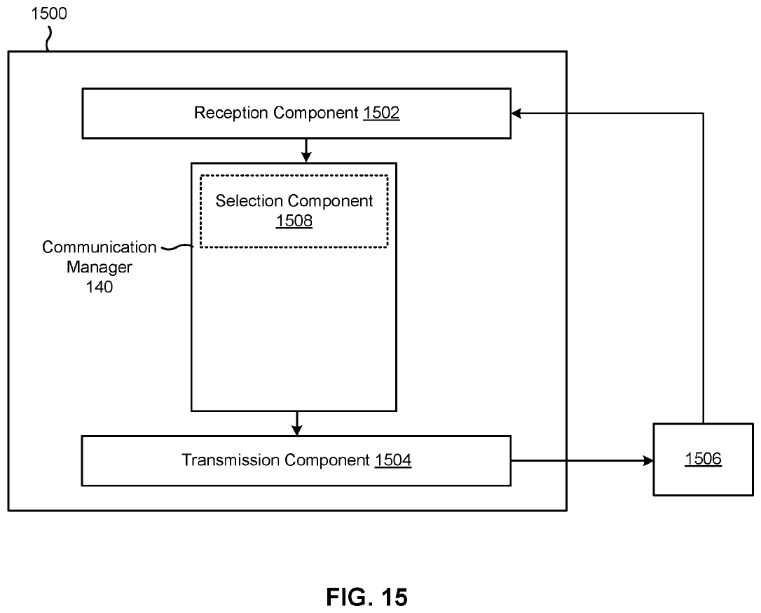

As shown in FIG. 11, in some aspects, process 1100 may include receiving, via sidelink communication, an inter-UE coordination request requesting coordination information associated with selecting a first resource for transmitting data (block 1110). For example, the UE (e.g., using communication manager 140 and/or reception component 1502, depicted in FIG. 15) may receive, via sidelink communication, an inter-UE coordination request requesting coordination information associated with selecting a first resource for transmitting data, as described above.

As further shown in FIG. 11, in some aspects, process 1100 may include transmitting an inter-UE coordination message including the coordination information associated with selecting the first resource (block 1120). For example, the UE (e.g., using communication manager 140 and/or transmission component 1504, depicted in FIG. 15) may transmit an inter-UE coordination message including the coordination information associated with selecting the first resource, as described above.

As further shown in FIG. 11, in some aspects, process 1100 may include retransmitting the inter-UE coordination message based at least in part on receiving inter-UE coordination message feedback indicating a negative acknowledgement associated with the inter-UE coordination message or based at least in part on not receiving the inter-UE coordination message feedback within a time period (block 1130). For example, the UE (e.g., using communication manager 140 and/or transmission component 1504, depicted in FIG. 15) may retransmit the inter-UE coordination message based at least in part on receiving inter-UE coordination message feedback indicating a negative acknowledgement associated with the inter-UE coordination message or based at least in part on not receiving the inter-UE coordination message feedback within a time period, as described above.

Process 1100 may include additional aspects, such as any single aspect or any combination of aspects described below and/or in connection with one or more other processes described elsewhere herein.

In a first aspect, the inter-UE coordination message is retransmitted via a resource that is reserved prior to transmitting the inter-UE coordination message.

In a second aspect, the inter-UE coordination message is retransmitted based at least in part on receiving the inter-UE coordination message feedback indicating the negative acknowledgement associated with the inter-UE coordination message, and the inter-UE coordination message feedback corresponds to a retransmission of the inter-UE coordination request.

In a third aspect, process 1100 includes selecting a resource for retransmitting the inter-UE coordination message based at least in part on receiving the inter-UE coordination message feedback indicating the negative acknowledgement associated with the inter-UE coordination message or based at least in part on not receiving the inter-UE coordination message feedback within the time period.

In a fourth aspect, process 1100 includes transmitting a positive acknowledgement associated with receiving the inter-UE coordination request; and performing a resource selection process associated with selecting the first resource based at least in part on receiving the inter-UE coordination request.

In a fifth aspect, the inter-UE coordination request is received from another UE and indicates a set of candidate resources, wherein the other UE determines the set of candidate resources based at least in part on sensing information obtained by the other UE.

In a sixth aspect, the coordination information indicates that a candidate resource, included in the set of candidate resources, corresponds to a preferred resource or a non-preferred resource.

In a seventh aspect, the first resource is included in the set of candidate resources, and the coordination information indicates that the first resource is a preferred resource.

In an eighth aspect, the other UE transmits the data via the first resource based at least in part on the coordination information indicating that the first resource is the preferred resource.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120) performs operations associated with a recovering procedure for inter-UE coordination message request and response failure.

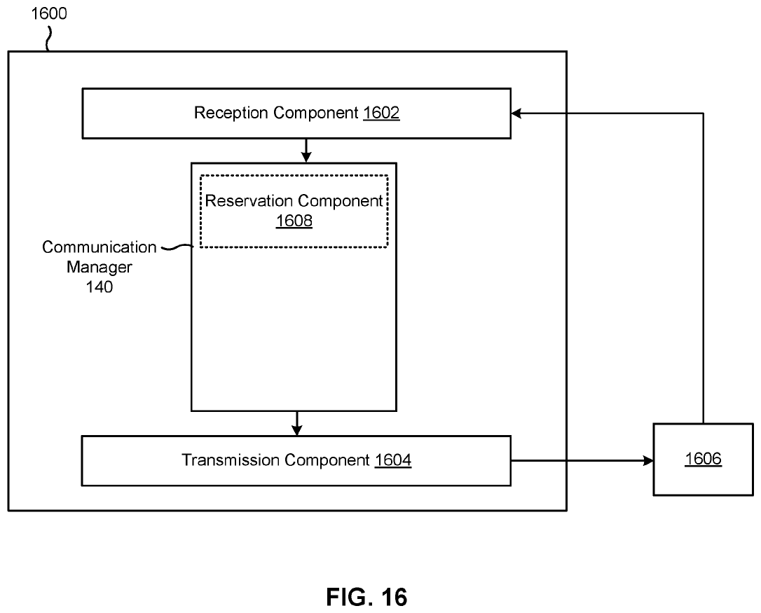

As shown in FIG. 12, in some aspects, process 1200 may include transmitting, via sidelink communication, an inter-UE coordination request requesting coordination information associated with selecting a first resource for transmitting data (block 1210). For example, the UE (e.g., using communication manager 140 and/or transmission component 1604, depicted in FIG. 16) may transmit, via sidelink communication, an inter-UE coordination request requesting coordination information associated with selecting a first resource for transmitting data, as described above.

As further shown in FIG. 12, in some aspects, process 1200 may include receiving an inter-UE coordination message indicating the first resource (block 1220). For example, the UE (e.g., using communication manager 140 and/or reception component 1602, depicted in FIG. 16) may receive an inter-UE coordination message indicating the first resource, as described above.

As further shown in FIG. 12, in some aspects, process 1200 may include retransmitting the inter-UE coordination request based at least in part on determining that the first resource is unavailable for transmitting the data (block 1230). For example, the UE (e.g., using communication manager 140 and/or transmission component 1604, depicted in FIG. 16) may retransmit the inter-UE coordination request based at least in part on determining that the first resource is unavailable for transmitting the data, as described above.

Process 1200 may include additional aspects, such as any single aspect or any combination of aspects described below and/or in connection with one or more other processes described elsewhere herein.

In a first aspect, the inter-UE coordination request is retransmitted based at least in part on a remaining portion of a packet delay budget associated with transmitting the data satisfying a condition.

In a second aspect, the inter-UE coordination request is retransmitted with the data via a last reserved data transmission resource, a second to last reserved data transmission resource, a reserved data transmission resource that is a quantity of slots from a reference time, wherein the reference time corresponds to a start time of a resource selection window occurring after the first resource is determined to be unavailable for transmitting the data, and wherein the quantity of slots corresponds to a time interval sufficient for retransmitting the inter-UE coordination request, receiving a new inter-UE coordination message, processing the new inter-UE coordination message, and selecting a new resource for transmitting the data.

In a third aspect, transmitting the data is associated with a semi-persistent scheduling (SPS) mode, wherein the inter-UE coordination request is retransmitted to reselect a resource for transmitting the data, and wherein the inter-UE coordination request is retransmitted during an SPS transmission period.

In a fourth aspect, the UE transmits the inter-UE coordination request and the data to a same coordinating UE and a receiver of the data transmission, and the retransmitted inter-UE coordination request is multiplexed with the data on a reserved data transmission resource.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a feedback component 1308, among other examples.

In some aspects, the apparatus 1300 may be configured to perform one or more operations described herein in connection with FIGS. 5-8. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The transmission component 1304 may transmit, via sidelink communication, an inter-UE coordination request requesting coordination information associated with selecting a first resource for transmitting data. In some aspects, the feedback component 1308 may receive a negative acknowledgement associated with the inter-UE coordination request. The transmission component 1304 may transmit, based at least in part on receiving the negative acknowledgement associated with the inter-UE coordination request or based at least in part on not receiving feedback associated with the inter-UE coordination request within a time period, the data via a second resource that is selected based at least in part on sensing information obtained by the UE.

The transmission component 1304 may retransmit the inter-UE coordination request based at least in part on receiving the negative acknowledgement associated with the inter-UE coordination request or based at least in part on not receiving the feedback associated with the inter-UE coordination request within the time period, wherein the data is transmitted via the second resource based at least in part on receiving a negative acknowledgement associated with retransmitting the inter-UE coordination request or based at least in part on not receiving feedback associated with retransmitting the inter-UE coordination request within another time period.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include a reservation component 1408, among other examples.

In some aspects, the apparatus 1400 may be configured to perform one or more operations described herein in connection with FIGS. 5-8. Additionally, or alternatively, the apparatus 1400 may be configured to perform one or more processes described herein, such as process 1000 of FIG. 10. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The transmission component 1404 may transmit, via sidelink communication, an inter-UE coordination request requesting coordination information associated with selecting a first resource for transmitting data. The reception component 1402 may receive inter-UE coordination request feedback indicating a positive acknowledgement associated with the inter-UE coordination request. The transmission component 1404 may retransmit the inter-UE coordination request via a second resource based at least in part on not receiving an inter-UE coordination message including the coordination information within a time period.

The reservation component 1408 may reserve the second resource prior to transmitting the inter-UE coordination request.

The transmission component 1404 may transmit data via a third resource based at least in part on not receiving the inter-UE coordination message including the coordination information within another time period, wherein the third resource is selected based at least in part on sensing information obtained by the UE, wherein the other time period corresponds to an inter-UE coordination response delay budget associated with receiving the inter-UE coordination message, and wherein the inter-UE coordination response delay budget is less than a packet delay budget associated with transmitting the data.

The reception component 1402 may receive the inter-UE coordination message after an expiration of the other time period, wherein the data is transmitted via the third resource based at least in part on the inter-UE coordination message being received after the expiration of the other time period.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include a selection component 1508, among other examples.

In some aspects, the apparatus 1500 may be configured to perform one or more operations described herein in connection with FIGS. 5-8. Additionally, or alternatively, the apparatus 1500 may be configured to perform one or more processes described herein, such as process 1100 of FIG. 11. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 may receive, via sidelink communication, an inter-UE coordination request requesting coordination information associated with selecting a first resource for transmitting data. The transmission component 1504 may transmit an inter-UE coordination message including the coordination information associated with selecting the first resource. The transmission component 1504 may retransmit the inter-UE coordination message based at least in part on receiving inter-UE coordination message feedback indicating a negative acknowledgement associated with the inter-UE coordination message or based at least in part on not receiving the inter-UE coordination message feedback within a time period.

The selection component 1508 may select a resource for retransmitting the inter-UE coordination message based at least in part on receiving the inter-UE coordination message feedback indicating the negative acknowledgement associated with the inter-UE coordination message or based at least in part on not receiving the inter-UE coordination message feedback within the time period.

The transmission component 1504 may transmit a positive acknowledgement associated with receiving the inter-UE coordination request, and performing a resource selection process associated with selecting the first resource based at least in part on receiving the inter-UE coordination request.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 140. The communication manager 140 may include a reservation component 1608, among other examples.

In some aspects, the apparatus 1600 may be configured to perform one or more operations described herein in connection with FIGS. 5-8. Additionally, or alternatively, the apparatus 1600 may be configured to perform one or more processes described herein, such as process 1200 of FIG. 12. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The transmission component 1604 may transmit, via sidelink communication, an inter-UE coordination request requesting coordination information associated with selecting a first resource for transmitting data. The reception component 1602 may receive an inter-UE coordination message indicating the first resource. The reservation component 1608 may determine that the first resource is unavailable for transmitting the data. The transmission component 1604 may retransmit the inter-UE coordination request based at least in part on determining that the first resource is unavailable for transmitting the data.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a UE, comprising: transmitting, via sidelink communication, an inter-UE coordination request requesting coordination information associated with selecting a first resource for transmitting data; and transmitting, based at least in part on receiving a negative acknowledgement associated with the inter-UE coordination request or based at least in part on not receiving feedback associated with the inter-UE coordination request within a time period, the data via a second resource that is selected based at least in part on sensing information obtained by the UE.

Aspect 2: The method of Aspect 1, further comprising: retransmitting the inter-UE coordination request based at least in part on receiving the negative acknowledgement associated with the inter-UE coordination request or based at least in part on not receiving the feedback associated with the inter-UE coordination request within the time period, wherein the data is transmitted via the second resource based at least in part on receiving a negative acknowledgement associated with retransmitting the inter-UE coordination request or based at least in part on not receiving feedback associated with retransmitting the inter-UE coordination request within another time period.

Aspect 3: The method of Aspect 2, wherein the inter-UE coordination request is retransmitted via a third resource, and the third resource is reserved prior to transmitting the inter-UE coordination request.

Aspect 4: The method of Aspect 2, wherein the inter-UE coordination request is retransmitted via a third resource, and the third resource is selected by the UE based at least in part on receiving the negative acknowledgement associated with the inter-UE coordination request or based at least in part on not receiving the feedback associated with the inter-UE coordination request within the time period.

Aspect 5: The method of one or more of Aspects 1 through 4, wherein the inter-UE coordination request is not retransmitted based at least in part on a latency or a level of interference associated with retransmitting the inter-UE coordination request.

Aspect 6: The method of one or more of Aspects 1 through 5, wherein the time period corresponds to an inter-UE coordination request delay budget, wherein the feedback associated with the inter-UE coordination request is received after expiration of the time period, and wherein the data is transmitted via the second resource based at least in part on the feedback being received after the expiration of the time period.

Aspect 7: The method of Aspect 6, wherein the inter-UE coordination request delay budget corresponds to a timeline configuration indication provided by an upper layer of the UE to a physical layer of the UE, and the inter-UE coordination request delay budget enables a latency associated with reserving the second resource to satisfy a condition associated with a packet delay budget associated with transmitting the data.

Aspect 8: The method of Aspect 7, wherein the condition is satisfied when an amount of time associated with selecting the second resource, reserving the second resource, transmitting the data, and retransmitting the data is less than the packet delay budget.

Aspect 9: A method of wireless communication performed by a UE, comprising: transmitting, via sidelink communication, an inter-UE coordination request requesting coordination information associated with selecting a first resource for transmitting data; receiving inter-UE coordination request feedback indicating a positive acknowledgement associated with the inter-UE coordination request; and retransmitting the inter-UE coordination request via a second resource based at least in part on not receiving an inter-UE coordination message including the coordination information within a time period.

Aspect 10: The method of Aspect 9, further comprising: reserving the second resource prior to transmitting the inter-UE coordination request.

Aspect 11: The method of one or more of Aspects 9 and 10, wherein the second resource is reserved based at least in part on not receiving the inter-UE coordination message including the coordination information within the time period.

Aspect 12: The method of one or more of Aspects 9 through 11, further comprising: transmitting data via a third resource based at least in part on not receiving the inter-UE coordination message including the coordination information within another time period, wherein the third resource is selected based at least in part on sensing information obtained by the UE, wherein the other time period corresponds to an inter-UE coordination response delay budget associated with receiving the inter-UE coordination message, and the inter-UE coordination response delay budget is less than a packet delay budget associated with transmitting the data.

Aspect 13: The method of Aspect 12, further comprising: receiving the inter-UE coordination message after an expiration of the other time period, wherein the data is transmitted via the third resource based at least in part on the inter-UE coordination message being received after the expiration of the other time period.

Aspect 14: The method of Aspect 12, wherein the inter-UE coordination response delay budget corresponds to a timeline configuration indication provided by an upper layer of the UE to a physical layer of the UE, and the inter-UE coordination response delay budget enables a latency associated with reserving the second resource to satisfy a condition associated with a packet delay budget associated with transmitting the data.

Aspect 15: The method of Aspect 14, wherein the condition is satisfied when an amount of time associated with selecting the third resource, reserving the third resource, transmitting the data, and retransmitting the data is less than the packet delay budget.

Aspect 16: The method of Aspect 14, wherein the condition is satisfied when a remaining portion of the inter-UE coordination packet delay budget is less than, or equal to, a minimum time interval, the minimum time interval is preconfigured or configured by an upper layer of the UE, and the inter-UE coordination request indicates one or more of the time period or the other time period.

Aspect 17: A method of wireless communication performed by a UE, comprising: receiving, via sidelink communication, an inter-UE coordination request requesting coordination information associated with selecting a first resource for transmitting data; transmitting an inter-UE coordination message including the coordination information associated with selecting the first resource; and retransmitting the inter-UE coordination message based at least in part on receiving inter-UE coordination message feedback indicating a negative acknowledgement associated with the inter-UE coordination message or based at least in part on not receiving the inter-UE coordination message feedback within a time period.

Aspect 18: The method of Aspect 17, wherein the inter-UE coordination message is retransmitted via a resource that is reserved prior to transmitting the inter-UE coordination message.

Aspect 19: The method of one or more of Aspects 17 and 18, wherein the inter-UE coordination message is retransmitted based at least in part on receiving the inter-UE coordination message feedback indicating the negative acknowledgement associated with the inter-UE coordination message, and the inter-UE coordination message feedback corresponds to a retransmission of the inter-UE coordination request.

Aspect 20: The method of one or more of Aspects 17 through 19, further comprising: selecting a resource for retransmitting the inter-UE coordination message based at least in part on receiving the inter-UE coordination message feedback indicating the negative acknowledgement associated with the inter-UE coordination message or based at least in part on not receiving the inter-UE coordination message feedback within the time period.

Aspect 21: The method of one or more of Aspects 17 through 20, further comprising: transmitting a positive acknowledgement associated with receiving the inter-UE coordination request; and performing a resource selection process associated with selecting the first resource based at least in part on receiving the inter-UE coordination request.

Aspect 22: The method of one or more of Aspects 17 through 21, wherein the inter-UE coordination request is received from another UE and indicates a set of candidate resources, and the other UE determines the set of candidate resources based at least in part on sensing information obtained by the other UE.

Aspect 23: The method of Aspect 22, wherein the coordination information indicates that a candidate resource, included in the set of candidate resources, corresponds to a preferred resource or a non-preferred resource.

Aspect 24: The method of Aspect 22, wherein the first resource is included in the set of candidate resources, and the coordination information indicates that the first resource is a preferred resource.

Aspect 25: The method of Aspect 24, wherein the other UE transmits the data via the first resource based at least in part on the coordination information indicating that the first resource is the preferred resource.

Aspect 26: A method of wireless communication performed by a UE, comprising: transmitting, via sidelink communication, an inter-UE coordination request requesting coordination information associated with selecting a first resource for transmitting data; receiving an inter-UE coordination message indicating the first resource; and retransmitting the inter-UE coordination request based at least in part on determining that the first resource is unavailable for transmitting the data.

Aspect 27: The method of Aspect 26, wherein the inter-UE coordination request is retransmitted based at least in part on a remaining portion of a packet delay budget associated with transmitting the data satisfying a condition.

Aspect 28: The method of one or more of Aspects 26 and 27, wherein the inter-UE coordination request is retransmitted with the data via: a last reserved data transmission resource, a second to last reserved data transmission resource, or a reserved data transmission resource that is a quantity of slots from a reference time, wherein the reference time corresponds to a start time of a resource selection window occurring after the first resource is determined to be unavailable for transmitting the data, and the quantity of slots corresponds to a time interval sufficient for retransmitting the inter-UE coordination request, receiving a new inter-UE coordination message, processing the new inter-UE coordination message, and selecting a new resource for transmitting the data.

Aspect 29: The method of one or more of Aspects 26 through 28, wherein transmitting the data is associated with an SPS mode, the inter-UE coordination request is retransmitted to reselect a resource for transmitting the data, and the inter-UE coordination request is retransmitted during an SPS transmission period.

Aspect 30: The method of Aspect 29, wherein the UE transmits the inter-UE coordination request and the data to a same coordinating UE and a receiver of the data transmission, and wherein the retransmitted inter-UE coordination request is multiplexed with the data on a reserved data transmission resource.

Aspect 31: An apparatus for wireless communication at a device, comprising a processor; memory coupled with the processor; and instructions stored in the memory and executable by the processor to cause the apparatus to perform the method of one or more of Aspects 1 through 8.

Aspect 32: A device for wireless communication, comprising a memory and one or more processors coupled to the memory, the one or more processors configured to perform the method of one or more of Aspects 1 through 8.

Aspect 33: An apparatus for wireless communication, comprising at least one means for performing the method of one or more of Aspects 1 through 8.

Aspect 34: A non-transitory computer-readable medium storing code for wireless communication, the code comprising instructions executable by a processor to perform the method of one or more of Aspects 1 through 8.

Aspect 35: A non-transitory computer-readable medium storing a set of instructions for wireless communication, the set of instructions comprising one or more instructions that, when executed by one or more processors of a device, cause the device to perform the method of one or more of Aspects 1 through 8.

Aspect 36: An apparatus for wireless communication at a device, comprising a processor; memory coupled with the processor; and instructions stored in the memory and executable by the processor to cause the apparatus to perform the method of one or more of Aspects 9 through 16.

Aspect 37: A device for wireless communication, comprising a memory and one or more processors coupled to the memory, the one or more processors configured to perform the method of one or more of Aspects 9 through 16.

Aspect 38: An apparatus for wireless communication, comprising at least one means for performing the method of one or more of Aspects 9 through 16.

Aspect 39: A non-transitory computer-readable medium storing code for wireless communication, the code comprising instructions executable by a processor to perform the method of one or more of Aspects 9 through 16.

Aspect 40: A non-transitory computer-readable medium storing a set of instructions for wireless communication, the set of instructions comprising one or more instructions that, when executed by one or more processors of a device, cause the device to perform the method of one or more of Aspects 9 through 16.

Aspect 41: An apparatus for wireless communication at a device, comprising a processor; memory coupled with the processor; and instructions stored in the memory and executable by the processor to cause the apparatus to perform the method of one or more of Aspects 17 through 25.

Aspect 42: A device for wireless communication, comprising a memory and one or more processors coupled to the memory, the one or more processors configured to perform the method of one or more of Aspects 17 through 25.

Aspect 43: An apparatus for wireless communication, comprising at least one means for performing the method of one or more of Aspects 17 through 25.

Aspect 44: A non-transitory computer-readable medium storing code for wireless communication, the code comprising instructions executable by a processor to perform the method of one or more of Aspects 17 through 25.

Aspect 45: A non-transitory computer-readable medium storing a set of instructions for wireless communication, the set of instructions comprising one or more instructions that, when executed by one or more processors of a device, cause the device to perform the method of one or more of Aspects 17 through 25.

Aspect 46: An apparatus for wireless communication at a device, comprising a processor; memory coupled with the processor; and instructions stored in the memory and executable by the processor to cause the apparatus to perform the method of one or more of Aspects 26 through 30.

Aspect 47: A device for wireless communication, comprising a memory and one or more processors coupled to the memory, the one or more processors configured to perform the method of one or more of Aspects 26 through 30.

Aspect 48: An apparatus for wireless communication, comprising at least one means for performing the method of one or more of Aspects 26 through 30.

Aspect 49: A non-transitory computer-readable medium storing code for wireless communication, the code comprising instructions executable by a processor to perform the method of one or more of Aspects 26 through 30.

Aspect 50: A non-transitory computer-readable medium storing a set of instructions for wireless communication, the set of instructions comprising one or more instructions that, when executed by one or more processors of a device, cause the device to perform the method of one or more of Aspects 26 through 30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, via sidelink communication, an inter-UE coordination request requesting coordination information associated with selecting a first resource for transmitting data; and
transmit, based at least in part on receiving a negative acknowledgement associated with the inter-UE coordination request or based at least in part on not receiving feedback associated with the inter-UE coordination request within a time period, the data via a second resource that is selected based at least in part on sensing information obtained by the UE.

2. The UE of claim 1, wherein the one or more processors are further configured to:
retransmit the inter-UE coordination request based at least in part on receiving the negative acknowledgement associated with the inter-UE coordination request or based at least in part on not receiving the feedback associated with the inter-UE coordination request within the time period, wherein the data is transmitted via the second resource based at least in part on receiving a negative acknowledgement associated with retransmitting the inter-UE coordination request or based at least in part on not receiving feedback associated with retransmitting the inter-UE coordination request within another time period.

3. The UE of claim 2, wherein the inter-UE coordination request is retransmitted via a third resource, and wherein the third resource is reserved prior to transmitting the inter-UE coordination request.

4. The UE of claim 2, wherein the inter-UE coordination request is retransmitted via a third resource, and wherein the third resource is selected by the UE based at least in part on receiving the negative acknowledgement associated with the inter-UE coordination request or based at least in part on not receiving the feedback associated with the inter-UE coordination request within the time period.

5. The UE of claim 1, wherein the inter-UE coordination request is not retransmitted based at least in part on a latency or a level of interference associated with retransmitting the inter-UE coordination request.

6. The UE of claim 1, wherein the time period corresponds to an inter-UE coordination request delay budget, wherein the feedback associated with the inter-UE coordination request is received after expiration of the time period, and wherein the data is transmitted via the second resource based at least in part on the feedback being received after the expiration of the time period.

7. The UE of claim 6, wherein the inter-UE coordination request delay budget corresponds to a timeline configuration indication provided by an upper layer of the UE to a physical layer of the UE, and wherein the inter-UE coordination request delay budget enables a latency associated with reserving the second resource to satisfy a condition associated with a packet delay budget associated with transmitting the data.

8. The UE of claim 7, wherein the condition is satisfied when an amount of time associated with selecting the second resource, reserving the second resource, transmitting the data, and retransmitting the data is less than the packet delay budget.

9. A user equipment (UE) for wireless communication, comprising:
a memory; and
one or more processors, coupled to the memory, configured to:
transmit, via sidelink communication, an inter-UE coordination request requesting coordination information associated with selecting a first resource for transmitting data;
receive inter-UE coordination request feedback indicating a positive acknowledgement associated with the inter-UE coordination request; and
retransmit the inter-UE coordination request via a second resource based at least in part on not receiving an inter-UE coordination message including the coordination information within a time period.

10. The UE of claim 9, wherein the one or more processors are further configured to:
reserve the second resource prior to transmitting the inter-UE coordination request.

11. The UE of claim 9, wherein the second resource is reserved based at least in part on not receiving the inter-UE coordination message including the coordination information within the time period.

12. The UE of claim 9, wherein the one or more processors are further configured to:
transmit data via a third resource based at least in part on not receiving the inter-UE coordination message including the coordination information within another time period, wherein the third resource is selected based at least in part on sensing information obtained by the UE, wherein the other time period corresponds to an inter-UE coordination response delay budget associated with receiving the inter-UE coordination message, and wherein the inter-UE coordination response delay budget is less than a packet delay budget associated with transmitting the data.

13. The UE of claim 12, wherein the one or more processors are further configured to:
receive the inter-UE coordination message after an expiration of the other time period, wherein the data is transmitted via the third resource based at least in part on the inter-UE coordination message being received after the expiration of the other time period.

14. The UE of claim 12, wherein the inter-UE coordination response delay budget corresponds to a timeline configuration indication provided by an upper layer of the UE to a physical layer of the UE, and wherein the inter-UE coordination response delay budget enables a latency associated with reserving the second resource to satisfy a condition associated with a packet delay budget associated with transmitting the data.

15. The UE of claim 14, wherein the condition is satisfied when an amount of time associated with selecting the third resource, reserving the third resource, transmitting the data, and retransmitting the data is less than the packet delay budget.

16. The UE of claim 14, wherein the condition is satisfied when a remaining portion of the inter-UE coordination packet delay budget is less than, or equal to, a minimum time interval, wherein the minimum time interval is preconfigured or configured by an upper layer of the UE, and wherein the inter-UE coordination request indicates one or more of the time period or the other time period.

17. A user equipment (UE) for wireless communication, comprising:
a memory; and
one or more processors, coupled to the memory, configured to:
receive, via sidelink communication, an inter-UE coordination request requesting coordination information associated with selecting a first resource for transmitting data;
transmit an inter-UE coordination message including the coordination information associated with selecting the first resource; and
retransmit the inter-UE coordination message based at least in part on receiving inter-UE coordination message feedback indicating a negative acknowledgement associated with the inter-UE coordination message or based at least in part on not receiving the inter-UE coordination message feedback within a time period.

18. The UE of claim 17, wherein the inter-UE coordination message is retransmitted via a resource that is reserved prior to transmitting the inter-UE coordination message.

19. The UE of claim 17, wherein the inter-UE coordination message is retransmitted based at least in part on receiving the inter-UE coordination message feedback indicating the negative acknowledgement associated with the inter-UE coordination message, and wherein the inter-UE coordination message feedback corresponds to a retransmission of the inter-UE coordination request.

20. The UE of claim 17, wherein the one or more processors are further configured to:
select a resource for retransmitting the inter-UE coordination message based at least in part on receiving the inter-UE coordination message feedback indicating the negative acknowledgement associated with the inter-UE coordination message or based at least in part on not receiving the inter-UE coordination message feedback within the time period.

21. The UE of claim 17, wherein the one or more processors are further configured to:
transmit a positive acknowledgement associated with receiving the inter-UE coordination request; and
perform a resource selection process associated with selecting the first resource based at least in part on receiving the inter-UE coordination request.

22. The UE of claim 17, wherein the inter-UE coordination request is received from another UE and indicates a set of candidate resources, wherein the other UE determines the set of candidate resources based at least in part on sensing information obtained by the other UE.

23. The UE of claim 22, wherein the coordination information indicates that a candidate resource, included in the set of candidate resources, corresponds to a preferred resource or a non-preferred resource.

24. The UE of claim 22, wherein the first resource is included in the set of candidate resources, and wherein the coordination information indicates that the first resource is a preferred resource.

25. The UE of claim 24, wherein the other UE transmits the data via the first resource based at least in part on the coordination information indicating that the first resource is the preferred resource.

26. A user equipment (UE) for wireless communication, comprising:
a memory; and
one or more processors, coupled to the memory, configured to:
transmit, via sidelink communication, an inter-UE coordination request requesting coordination information associated with selecting a first resource for transmitting data;
receive an inter-UE coordination message indicating the first resource; and
retransmit the inter-UE coordination request based at least in part on determining that the first resource is unavailable for transmitting the data.

27. The UE of claim 26, wherein the inter-UE coordination request is retransmitted based at least in part on a remaining portion of a packet delay budget associated with transmitting the data satisfying a condition.

28. The UE of claim 26, wherein the inter-UE coordination request is retransmitted with the data via a last reserved data transmission resource, a second to last reserved data transmission resource, or a reserved data transmission resource that is a quantity of slots from a reference time, wherein the reference time corresponds to a start time of a resource selection window occurring after the first resource is determined to be unavailable for transmitting the data, and wherein the quantity of slots corresponds to a time interval sufficient for retransmitting the inter-UE coordination request, receiving a new inter-UE coordination message, processing the new inter-UE coordination message, and selecting a new resource for transmitting the data.

29. The UE of claim 26, wherein transmitting the data is associated with a semi-persistent scheduling (SPS) mode, wherein the inter-UE coordination request is retransmitted to reselect a resource for transmitting the data, and wherein the inter-UE coordination request is retransmitted during an SPS transmission period.

30. The UE of claim 29, wherein the UE transmits the inter-UE coordination request and the data to a same coordinating UE and a receiver of the data transmission, and wherein the retransmitted inter-UE coordination request is multiplexed with the data on a reserved data transmission resource.
